(19) United States
(12) Patent Application Publication
(10) Pub. No.: US 2012/0156577 A1
(43) Pub. Date: Jun. 21, 2012

(54) METHODS FOR FORMING ELECTRODES FOR WATER ELECTROLYSIS AND OTHER ELECTROCHEMICAL TECHNIQUES

(75) Inventors: Vladimir Bulovic, Lexington, MA (US); Daniel G. Nocera, Winchester, MA (US); Elizabeth R. Young, Amherst, MA (US); Ronny Costi, Brighton, MA (US); Sarah Paydavosi, Arlington, MA (US)

(73) Assignee: Massachusetts Institute of Technology, Cambridge, MA (US)

(21) Appl. No.: 13/213,690

(22) Filed: Aug. 19, 2011

Related U.S. Application Data
(60) Provisional application No. 61/375,729, filed on Aug. 20, 2010.
(60) Provisional application No. 61/433,029, filed on Jan. 14, 2011.

(51) Int. Cl. H01M 8/18; C25B 1/02; C25D 3/00; C25B 11/04; C25D 3/12

(52) U.S. Cl. 429/417; 204/292; 205/269; 205/318; 205/261; 205/633

(57) ABSTRACT

Methods of forming electrodes for electrolysis of water and other electrochemical techniques are provided. In some embodiments, the electrode comprising a current collector and a catalytic material. The method of forming the electrode may comprising immersing a current collector comprising a metallic species in an oxidation state of zero in a solution comprising anionic species, and causing a catalytic material to form on the current collector by application of a voltage to the current collector, wherein the catalytic material comprises metallic species in an oxidation state greater than zero and the anionic species.

### RELATED APPLICATIONS

This application claims the benefit of U.S. Provisional Patent Application Ser. No. 61/375,729, filed Aug. 20, 2010, and entitled “Methods for Forming Electrodes for Water Electrolysis and Other Electrochemical Techniques,” and U.S. Provisional Patent Application Ser. No. 61/433,029, filed Jan. 14, 2011, and entitled “Methods for Forming Electrodes for Water Electrolysis And Other Electrochemical Techniques,” to each of which are incorporated herein by reference in their entirety for all purposes.

### STATEMENT REGARDING FEDERALLY SPONSORED RESEARCH OR DEVELOPMENT

This invention was made with Government support under Grant No. CHE0936816, awarded by the National Science Foundation. The Government has certain rights in this invention.

### FIELD OF THE INVENTION

The present invention relates to electrodes and methods of making electrodes. In some embodiments, an electrode comprises a catalytic material and a current collector. The method may involve providing a current collector comprising metallic species having an oxidation state of zero, and immersing the current collector in a solution comprising anionic species, wherein a catalytic material forms on the current collector by application of a voltage to the current collector and comprises the metallic species having an oxidation state greater than zero and the anionic species. The electrode may be used for the production of oxygen gas from water, which can be used for energy storage, energy conversion, oxygen and/or hydrogen production, and the like.

### BACKGROUND OF THE INVENTION

Electrolysis of water, that is, splitting water into its constituent elements oxygen and hydrogen gases, is a very important process not only for the production of oxygen and/or hydrogen gases, but for energy storage. Energy is consumed in splitting water into hydrogen and oxygen gases and, when hydrogen and oxygen gases are re-combined to form water, energy is released.

In order to store energy via electrolysis, catalysts are required which efficiently mediate the bond rearranging “water splitting” reaction to O₂ and H₂. The standard reduction potentials for the O₂/H₂O and H₂O/H₂ half-cells are given by Equation 1 and Equation 2.

$$\begin{matrix}{O}_{2} + 4 {H}^{+} + 4 {e}^{-} ↔ {H}_{2} O & {E}^{0} = 0.00 - 0.059 ( pH ) V \\ 2 {H}_{2} ↔ 4 {H}^{+} + 4 {e}^{-} & {E}^{0} = 0.00 - 0.059 ( pH ) V \\ 2 {H}_{2} + {O}_{2} ↔ 2 {H}_{2} O & \end{matrix} \qquad \begin{matrix}( 1 ) \\ ( 2 )\end{matrix}$$

For a catalyst to be efficient for this conversion, the catalyst should operate close to the thermodynamically-limiting value of each half reaction, which are defined by half-cell potentials, E^{o}. Voltage in addition to E^{o} that is required to attain a given catalytic activity, referred to as overpotential, limits the conversion efficiency and considerable effort has been expended by many researchers in efforts to reduce overpotential in this reaction. Of the two reactions, anodic water oxidation may be considered to be more complicated and challenging. It may be considered that oxygen gas production from water at low overpotential and under benign conditions presents the greatest challenge to water electrolysis. The oxidation of water to form oxygen gas requires removing four electrons coupled to the removal of four protons in order to avoid prohibitively high-energy intermediates. In addition to controlling multi-proton-coupled electron transfer reactions, a catalyst, in some cases, should also be able to tolerate prolonged exposure to oxidizing conditions. Much research has gone into improving systems and techniques for water electrolysis. For example, recently, Nocera, et al. (e.g., see Kanan et al., Science 2008, 321, 1072-5) developed catalytic materials that improve the efficiency of water electrolysis.

### SUMMARY OF THE INVENTION

According to some aspects of the present invention, methods for making electrodes comprising catalytic materials are provided. In some embodiments, a method for making an electrode comprising a catalytic material comprises immersing a current collector in a solution comprising anionic species, wherein the current collector comprises a layer of a metallic species in an oxidation state of zero, wherein the layer of the metallic species has an average thickness of less than about 2 mm, and causing a catalytic material to form on the current collector by application of a voltage to the current collector, wherein the catalytic material comprises the metallic species in an oxidation state greater than zero and the anionic species.

In other embodiments, a method for making an electrode comprising a catalytic material comprises immersing a current collector in a solution comprising anionic species, wherein the current collector comprises a metallic species in an oxidation state of zero, and causing a catalytic material to form on the current collector by application of a voltage to the current collector, wherein the catalytic material comprises the metallic species in an oxidation state greater than zero and the anionic species, wherein following formation of the catalytic material, the current collector comprises less than about 10% of the metallic species in an oxidation state of zero.

According to some aspects of the present invention, electrodes comprising a catalytic material are provided. In some embodiments, an electrode comprising a catalytic material is provided, wherein the electrode is produced by immersing a current collector in a solution comprising anionic species, wherein the current collector comprises a layer of a metallic species in an oxidation state of zero, wherein the layer of the metallic species has an average thickness of less than about 2 mm, and causing a catalytic material to form on the current collector by application of a voltage to the current collector, wherein the catalytic material comprises the metallic species in an oxidation state greater than zero and the anionic species.

In other embodiments, an electrode comprising a catalytic material is provided, wherein the electrode is produced by immersing a current collector in a solution comprising anionic species, wherein the current collector comprises a metallic species in an oxidation state of zero, and causing a catalytic material to form on the current collector by application of a voltage to the current collector, wherein the catalytic material comprises the metallic species in an oxidation state greater than zero and the anionic species, and wherein following formation of the catalytic material, the current collector comprises less than about 10% of the metallic species in an oxidation state of zero.

### BRIEF DESCRIPTION OF THE DRAWINGS

FIG. 1 shows steps (A)-(C) of a non-limiting method of forming an electrode of the present invention, according to some embodiments.

FIG. 2 shows an image of the electrochemical cell utilized for formation and electrochemical characterization of the Co-Pi catalyst, according to a non-limiting embodiment.

FIG. 3A shows an image of a thin-film cobalt electrode comprising copper tape and Microstop lacquer.

FIG. 3B shows an image of a thin-film cobalt electrode immersed in 0.1 M KPi under conditions causing catalytic activity.

FIG. 3C shows current density traces for bulk electrolysis in 0.1 M KPi electrolyte, for (i) Co-Pi formation on thin-film cobalt anodes and (ii) Co-Pi formation on FTO-coated glass anodes with 0.5 mM Co²⁺.

FIG. 4 shows Auger electron spectroscopy spectrum obtained for Co-Pi films formed on the cobalt thin-film electrode.

FIG. 5 shows Tafel plot of catalyst films operation under various applied potentials for (ii) Co-Pi films on FTO (i) Co-Pi films on Co metal electrodes.

FIG. 6 shows AFM images used to quantify the height profiles of the two Co-Pi films.

FIG. 7 shows images and Auger atomic concentration analysis for Co-Pi formed on cobalt thin-film electrodes.

FIG. 8 shows (A) SEM analysis and (B) EDAX analysis of a Co-Pi formed from a thin film deposited on a silicon substrate, according to some embodiments.

FIG. 9 shows representative SEM images and a plot of the current density versus time, according to some embodiments.

FIG. 10A shows a schematic of the device architecture for an ITO/Si/Co/Co-Pi photoanode.

FIG. 10B shows an SEM image of the Co-Pi film formed on top of the ITO/Si/Co electrode, according to some embodiments.

FIG. 10C shows the Co-Pi film formed by electrodeposition on ITO/Si/ITO substrate, according to some embodiments.

FIG. 11 shows cyclic voltamograms of (a) ITO/Si/Co/Co-Pi electrode, (b) ITO/Si/ITO/Co-Pi electrode, and (c) ITO/Si/ITO electrode, according to some embodiments.

FIG. 12 shows current density vs. applied potential (I/V) curves for ITO/Si/ITO electrode, ITO/Si/Co/Co-Pi electrode, ITO/Si/ITO/Co-Pi electrode, and glass/Co/Co-Pi electrode, accordingly to some embodiments.

Other aspects, embodiments, and features of the invention will become apparent from the following detailed description when considered in conjunction with the accompanying drawings. The accompanying figures are schematic and are not intended to be drawn to scale. For purposes of clarity, not every component is labeled in every figure, nor is every component of each embodiment of the invention shown where illustration is not necessary to allow those of ordinary skill in the art to understand the invention. All patent applications and patents incorporated herein by reference are incorporated by reference in their entirety. In case of conflict, the present specification, including definitions, will control.

### DETAILED DESCRIPTION

The present invention provides methods and electrodes useful in electrochemical reactions, including the electrolysis of water to form oxygen gas. Techniques of the invention can be simpler to implement than other methods for the formation of electrodes for similar functions, can be readily used to make electrodes of varying sizes, shapes, and other morphologies, and can protect some components of the electrode from corrosion or other decomposition mechanisms under some circumstances. For example, methods described herein may be used to form an electrode comprising a catalytic material and a conductive and/or semiconductive material (e.g., a current collector), wherein the conductive and/or semiconductive material is generally unstable in the operating conditions of the electrochemical reaction and/or the conditions for forming the electrode, but is protected from corrosion or other decomposition mechanisms in the technique of the invention. In some cases, the methods described herein reduce or prevent poisoning or corrosion of a conductive and/or semiconductive material comprised in the current collector, wherein poisoning may be described as any chemical or physical change in the status of the electrode that may diminish or limit the use of an electrode in an electrochemical device and/or lead to erroneous measurements.

In one aspect, the present invention provides methods for making an electrode comprising a catalytic material, wherein the catalytic material comprises metallic species and anionic species. In some cases, the method involves immersing a current collector in a solution comprising anionic species, wherein the current collector comprises metallic species, and causing a catalytic material to form on the current collector by application of a voltage to the current collector. In some cases, the metallic species may exhibit a change in oxidation state prior to or during formation of the catalytic material. Electrodes are also provided, in some cases, wherein the electrode is prepared using the methods described herein.

In some embodiments, a method for forming an electrode comprising providing a current collector comprising a metallic species in an oxidation state of zero. For example, the current collector may comprise a metal such as cobalt or nickel. The current collector may be immersed in a solution comprising anionic species, wherein the anionic species is selected such that it can form a catalytic material comprising the metallic species in an oxidation state greater than zero and the anionic species. Upon application of a voltage, the metallic species may be oxidized to an oxidation state of greater than zero. A catalytic material comprising the anionic species and the metallic species in an oxidation state greater than zero may then form on the current collector. As will be understood by those of ordinary skill in the art, not every metallic species in an oxidation state of zero comprised in the current collector is necessarily oxidized to an oxidation state greater than zero upon application of a voltage to the current collector. In some cases, about 1%, about 5%, about 10%, about 15%, about 20%, about 30%, about 40%, about 50%, about 60%, about 70%, about 80%, about 90%, about 95%, about 98%, about 99%, or about 100% of the metallic species in an oxidation state of zero will be oxidized to an oxidation state greater than zero. In addition, not necessarily all metallic species which are oxidized to an oxidation state of greater than zero will be comprised in the catalytic material. For example, some of the oxidized metallic species may disperse into the solution in which the current collector is immersed.

As a specific example of a method for forming an electrode, a current collector may be provided comprising cobalt metal in an oxidation state of zero. For example, the current collector may comprise film of cobalt metal formed on a core material (e.g., a conductive material, a semiconductive material, and/or an insulating material), or the current collector may be cobalt metal. The current collector may be immersed in a solution comprising anionic species comprising phosphorus (e.g., phosphate). Upon application of a voltage, at least some of the cobalt atoms having an oxidation state of zero may be oxidized to cobalt ions having an oxidation state greater than zero (e.g., Co(II), Co(III), Co (IV)), and a catalytic material may form associated with the current collector that comprises the anionic species comprising phosphorus and at least some of the cobalt ions in an oxidation state greater than zero. In some cases, the cobalt ions may be oxidized to a first oxidation state (e.g., Co(II)), and may then be further oxidized into a second oxidation state (e.g., Co(III) or Co(IV)) upon formation of the catalytic material. In some cases, some of the cobalt ions in an oxidation state greater than zero may disperse into the solution and not be comprised in the catalytic material.

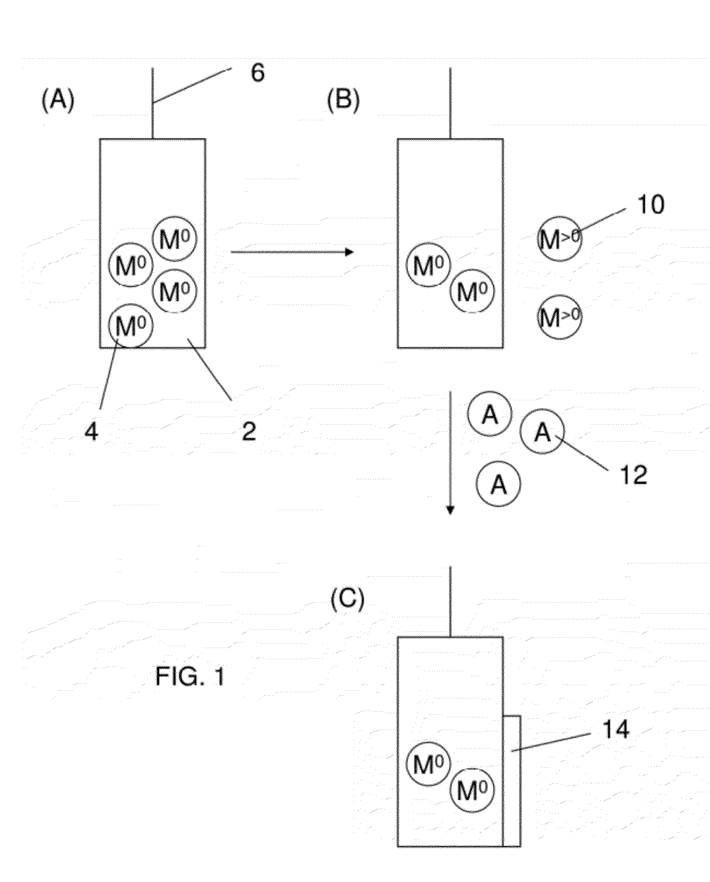

FIG. 1 depicts a non-limiting example of a method for forming an electrode. Current collector 2 is provided comprising metallic species 4 having an oxidation state of zero, as shown in step (A). Current collector 2 is in electrical communication 6 with a circuit including a power source (not shown) such as a photovoltaic cell, wind power generator, electrical grid, or the like. Upon application of a voltage to current collector 2, at least some of the metallic species may be oxidized to form metallic species 10 having an oxidation state greater than zero (e.g., M^{>0}), as shown in step (B). Oxidized metallic species 10 having an oxidation state greater than zero may interact with anionic species 12 near the electrode to form a substantially insoluble complex, thereby forming catalytic material 14 associated with at least a portion of the current collector, as shown in step (C).

Where a catalytic material is associated with a current collector in this manner in accordance with the invention, it typically accumulates in the form of a solid or near-solid at the current collector surface, upon exposure to an appropriate precursor solution and application of a voltage under appropriate conditions as described herein. Some of those conditions involve exposing the current collector to the forming conditions for a period of time, and at a voltage, such that a threshold amount of catalytic material associates with the current collector.

In one set of embodiments of the invention, a limited amount of metallic species with an oxidation state of zero (i.e., a precursor to a catalytic material, as described herein) is provided on an electrode/current collector at the outset of processes of the invention. In these embodiments, the limited amount of metallic species in an oxidation state of zero is provided when the electrode includes no adsorbed metal ionic/anionic catalytic species on the electrode, or includes no more than about 1% by weight, 3% by weight, 5% by weight, 7% by weight, or 10% by weight metal ionic/anionic catalytic species as compared to the weight of metallic species in an oxidation state of zero on the current collector/electrode. At this stage in development in the electrode, in one set of embodiments, the current collector carries metallic species with an oxidation state of zero in a layer having an average thickness of no more than about 100 microns, or no more than 200 microns, about 300 microns, about 400 microns, about 500 microns, about 600 microns, about 700 microns, about 800 microns, about 900 microns, about 1 mm, about 2 mm, about 3 mm, about 4 mm, or more. In another set of embodiments, the thickness of the metallic species with an oxidation state of zero, on the current collector, at this stage of electrode development, has a maximum thickness of no more than about 100 microns, or no more than about 200 microns, about 300 microns, about 400 microns, about 500 microns, about 600 microns, about 700 microns, about 800 microns, about 900 microns, about 1 mm, about 2 mm, about 3 mm, or about 4 mm. This set of embodiments can be applied to and used in combination with every other embodiment described herein. In some embodiments, the layer is present at one or more surfaces of the current collector of the present invention.

In embodiments where the current collector comprises a limited amount of metallic species in an oxidation state of zero (e.g., prior to application of a voltage), a significant portion of the metallic species may be converted into a catalytic material (e.g., as described herein, by oxidation to a metallic species having an oxidation state greater than zero). In some cases, greater than about 70%, greater than about 75%, greater than about 80%, greater than about 85%, greater than about 90%, greater than about 95%, greater than about 96%, greater than about 97%, greater than about 98%, greater than about 99%, greater than about 99.5%, or greater, may be converted into a catalytic material. It should be understood, however, that in some embodiments, at least some of the metallic species in an oxidation state of zero may be lost to the solution during the process of forming a catalytic material. In some embodiments, following formation of the catalytic material, the current collector may comprise less than about 20%, less than about 15%, less than about 10%, less than about 5%, less than about 4%, less than about 3%, less than about 2%, less than about 1%, less than about 0.5%, less than about 0.3%, less than about 0.1%, or less, of the metallic species in an oxidation state of zero.

Those of ordinary skill in the art will be aware of methods for determining the amount of metallic species in an oxidation state of zero which is converted to a catalytic material of the present invention. In some cases, the amount of material may be approximated by visual analysis. For example, the metallic species in an oxidation state of zero may be formed on a substrate (e.g., glass), and following conversion into a catalytic material, visual inspection of the material near the glass substrate (e.g., by looking through the back side of the glass substrate) may be observed to have changed color, texture, or another parameter which can be visually monitored. As another example, the material formed on a current collector may be analyzed using techniques such as scanning electron microscopy.

In some embodiments, using a current collector comprising an optimized amount of metallic species in an oxidation state of zero may be advantageous as compared to the use of current collectors comprising an increased amount of metallic species in an oxidation state of zero. In some cases, the efficiency of the electrode may be reduced if electrons/holes are continually being used to oxidize metallic species from an oxidation state of zero to an oxidation state greater than zero. That is, if the current collector comprises a large amount of metallic species in an oxidation state of zero, energy provided to the current collector may be used to oxidize the metallic species as compared to the energy being used in the electrochemical reaction. Additionally, the performance of a catalytic material may decrease when the catalytic material reaches a certain thickness because, for example, the catalytic material may be resistive and the transportation of electrons/holes through the catalytic material as compared to the underlying current collector may be reduced. Thus, build-up of too thick of a film of catalytic material may slow the transport of electrons/holes, and lead to decreased performance parameters. Also, too thick of a catalytic material may be unstable, and the catalytic material may dissociate (e.g., fall-off) the current collector if the material becomes too thick.

As described herein, the current collector may comprise one or more materials, wherein at least one of the materials comprises metallic species (e.g., in an oxidation state of zero). Voltage may be applied to the current collector at a suitable level and for a period of time to cause at least some of the metallic species to be oxidized and then at least some to become associated with the current collector in a catalytic material. The formation of the catalytic material may proceed until the potential (e.g., voltage) applied to the current collector is turned off, until there is a limiting quantity of materials (e.g., metallic species and/or anionic species), the catalytic material has reached a critical thickness beyond which additional film formation does not occur or is very slow, and/or until the metallic species comprised in the current collector is being oxidize very slowly or not at all.

Voltage may be applied to the current collector for minimums of about 1 minute, about 5 minutes, about 10 minutes, about 20 minutes, about 30 minutes, about 60 minutes, about 2 hours, about 4 hours, about 8 hours, about 12 hours, about 24 hours, and the like. In some cases, a potential may be applied to the current collector between 24 hours and about 30 seconds, between about 12 hours and about 1 minute, between about 8 hours and about 5 minutes, between about 4 hours and about 10 minutes, and the like. The voltages provided herein, in some cases, are supplied with reference to a normal hydrogen electrode (NHE). Those of ordinary skill in the art will be able to determine the corresponding voltages with respect to an alternative reference electrode by knowing the voltage difference between the specified reference electrode and NHE or by referring to an appropriate textbook or reference. In some cases, as described herein, wherein the current collector comprises a semiconductor material, voltage may be applied by exposing the current collector (e.g., the semiconductor material) to a source of electromagnetic radiation.

The voltage applied to the current collector may be held steady, may be linearly increased or decreased, and/or may be linearly increased and decreased (e.g., cyclic). In some cases, the voltage applied to the current collector may be substantially similar throughout the application of the voltage. That is, the voltage applied to the current collector might not be varied significantly during the time that the voltage in applied to the current collector. In such instances, the voltage applied to the current collect may be at least about 0.1 V, at least about 0.2 V, at least about 0.4 V, at least about 0.5 V, at least about 0.7 V, at least about 0.8 V, at least about 0.9 V, at least about 1.0 V, at least about 1.2 V, at least about 1.4 V, at least about 1.6 V, at least about 1.8 V, at least about 2.0 V, at least about 3 V, at least about 4 V, at least about 5 V, at least about 10 V, and the like. In some cases, the voltage applied is between about 1.0 V and about 1.5 V, about 1.1 V and about 1.4 V, or is about 1.1 V. The potential applied may or might not be such that oxygen gas is being formed during the formation of the electrode. In some cases, the morphology of the catalytic material may differ depending on the potential applied to the current collector during formation of the electrode.

The anionic species may be provided in a solution in any suitable form. The anionic species may be provided to the solution by substantially dissolving at least one compound comprising the anionic species (e.g., an anionic compound). The ionic compound may be of any composition, such as a solid, a liquid, a gas, a gel, a crystalline material, and the like. The dissolution of the anionic compound may be facilitated by agitation of the solution (e.g., stirring) and/or heating of the solution. In some cases, the solution may be sonicated. The anionic species may be provided in an amount such that the concentration of the anionic species is at least about 0.1 mM, at least about 0.5 mM, at least about 1 mM, at least about 10 mM, at least about 0.1 M, at least about 0.5 M, at least about 1 M, at least about 2 M, at least about 5M, or greater.

The solution comprising the anionic species may be formed from any suitable material. In most cases, the solution may be a liquid and may comprise water. In some embodiments the solution consists of or consists essentially of water, i.e. be essentially pure water or an aqueous solution that behaves essentially identically to pure water, in each case, with the minimum electrical conductivity necessary for an electrochemical device to function. In some embodiments, the solution is selected such that the anionic species is substantially soluble. In some cases, when the electrode is to be used in a device immediately after formation, the solution may be selected such that it comprises water (or other fuel) to be oxidized by a device and/or method as described herein. For example, in instances where oxygen gas is to be catalytically produced from water, the solution may comprise water (e.g., provided from a water source).

In some cases, the pH of the solution in which the current collector is immersed (e.g., comprising the anionic species) may be about neutral. That is, the pH of the solution may be between about 6.0 and about 8.0, between about 6.5 and about 7.5, and/or the pH is about 7.0. In other cases, the pH of the solution is about neutral or acidic. In these cases, the pH may be between about 0 and about 8, between about 1 and about 8, between about 2 and about 8, between about 3 and about 8, between about 4 and about 8, between about 5 and about 8, between about 0 and about 7.5, between about 1 and about 7.5, between about 2 and about 7.5, between about 3 and about 7.5, between about 4 and about 7.5, or between about 5 and about 7.5. In some embodiments, the pH of the solution may be about neutral and/or basic, for example, between about 7 and about 14, between about 8 and about 14, between about 8 and about 13, between about 10 and about 14, greater than 14, or the like. The pH of the solution may be selected such that the anionic species are in the desired state. For example, some anionic species may be affected by a change in pH level, for example, phosphate. That is, if the solution is basic (greater than about pH 12), the majority of the phosphate is in the form PO₄⁻³; if the solution is approximately neutral, the phosphate is in approximately equal amounts of the form HPO₄⁻² and the form H₂PO₄⁻¹; if the solution is slightly acidic (less than about pH 6), the phosphate is mostly in the form H₂PO₄⁻. The pH level may also affect the solubility constant for the anionic species and the metallic species, which may affect the formation of the catalytic material as described herein.

The term “current collector,” as used herein, will be understood by those of ordinary skill in the art and refers to an article which is electrically connectable to an external circuit for application of voltage and/or current to the current collector, for receipt of power in the form of electrons and/or electron holes produced by a power source, or the like, and, where the current collector is used in connection with a catalytic reaction involving a catalytic material auxiliary to the current collector, is constructed and arranged for supporting the catalytic material and exposing the catalytic material to a medium within which an electrochemical reaction is to be conducted. Generally, the current collector comprises the metallic species (optionally in addition to other material, as noted further herein) in an oxidation state of zero, and a catalytic material may form associated with the current collector under certain conditions. In some cases, the current collector refers to the material between the catalytic material and the external circuit, through which electric current flows during a reaction of the invention or during formation of the electrode.

In some embodiments, the current collector can also be considered by one of ordinary skill in the art to be a “working electrode.” As will be understood by those of ordinary skill in the art, in many applications, an electrochemical system comprises a working electrode, a references electrode, and a counter electrode. The working electrode is generally the electrode which is monitored by a potentiostat (or other external circuitry) during electrochemical reactions/methods (e.g., bulk electrolysis, cyclic voltammetry). Generally, the working electrode experiences a given potential (e.g., relative to the reference electrode) at which the potentiostat/electrical circuit is set and is the electrode at which the current passing through the electrochemical circuit is measured.

The current collector may comprise, consist essentially of, or consist of the metallic species. In some embodiments, the current collector is formed essentially of the metallic species. In some embodiments, the current collector comprises a plurality of materials, provided that at least a portion of the current collector comprises the metallic species (e.g., in an oxidation state of zero). In some cases, the current collector comprises at least two materials, at least three materials, at least four materials, etc. In certain embodiments, the current collector comprises a core material that does not consist of, consist essentially of, or comprise the metallic species, and at least a portion of the core material is associated with the metallic species (e.g., in an oxidation state of zero). Generally, the portion of the core material associated with the metallic species is in contact with the solution comprising the anionic species.

In some cases, the current collector comprises a core material and a film of the metallic species associated with the core material. The film may substantially cover the surface of the core material. The thickness of the film may be at least about or about 1 nm, at least about or about 10 nm, at least about or about 50 nm, at least about or about 100 nm, at least about or about 200 nm, at least about or about 300 nm, at least about or about 400 nm, at least about or about 500 nm, at least about or about 600 nm, at least about or about 700 nm, at least about or about 800 nm, at least about or about 900 nm, at least about or about 1 um (micrometer), at least about or about 10 um, at least about or about 100 um, at least about or about 1 mm, or more.

Additionally materials the current collector may comprise includes material which are substantially non-conductive (e.g., insulating), semiconducting, and/or substantially conductive. As a non-limiting example, the current collector may comprise a substantially non-conductive core material and an outer layer of substantially conductive material, wherein the outer layer comprises at least some metallic species, or wherein the outer layer is associated with at least some metallic species (e.g., a non conductive core material, a first layer comprising a conductive material and a second layer comprising the metallic species). Non-limiting examples of non-conductive materials include inorganic substrates, (e.g., quartz, glass, etc.) and polymeric substrates (e.g., polyethylene terephthalate, polyethylene naphthalate, polycarbonate, polystyrene, polypropylene, etc.). As another example, the current collector comprises a substantially conductive core material. As yet another example, the current collector comprises a semiconductor core material.

Non-limiting examples of substantially conductive materials the current collector may comprise includes indium tin oxide (ITO), fluorine tin oxide (FTO), antimony-doped tin oxide (ATO), aluminum-doped zinc oxide (AZO), glassy carbon, carbon mesh, metals, metal alloys, lithium-containing compounds, metal oxides (e.g., platinum oxide, nickel oxide, zinc oxide, tin oxide, vanadium oxide, zinc-tin oxide, indium oxide, indium-zinc oxide), graphite, zeolites, and the like. Non-limiting examples of suitable metals the current collector may comprise (including metals comprised in metal alloys and/or metal oxides) include gold, copper, silver, platinum, ruthenium, rhodium, osmium, iridium, nickel, cadmium, tin, lithium, chromium, calcium, titanium, aluminum, cobalt, zinc, vanadium, nickel, palladium, copper, or the like, and combinations thereof (e.g., alloys such as palladium silver).

The current collector may also comprise other metals and/or non-metals known to those of ordinary skill in the art as conductive (e.g., ceramics, conductive polymers). In some cases, the current collector may comprise an inorganic conductive material (e.g., copper iodide, copper sulfide, titanium nitride, etc.), an organic conductive material (e.g., conductive polymer such as polyaniline, polythiophene, polypyrrole, etc.), and laminates and/or combinations thereof.

In some embodiments, the current collector comprises a semiconductor material, for example, an n-type semiconductor material. In some cases, the semiconductor material may be a photoactive composition (e.g., may be capable of acting as a photoanode and/or a photocathode). The photoactive composition may be selected such that the band gap of the material is between about 1.0 and about 2.0 eV, between about 1.2 and about 1.8 eV, between about 1.4 and about 1.8 eV, between about 1.5 and about 1.7 eV, is about 2.0 eV, or the like. The photoactive composition may also have a Fermi level which is compatible with the electrolyte and/or a small work function (e.g., such that electrons may diffuse into the water to attain thermal equilibrium). It should be noted, that in embodiments where the current collector comprises a semiconducting material, the term application of a voltage when used in connection with these embodiments may be synonymous with the term formation of a photovoltage (e.g., formation of electron/hole pairs in a material by exposing the semiconducting material to electromagnetic radiation). For example, in some embodiments, the current collector comprises a core material comprising a photoactive material (e.g., a photoactive electrode) and voltage is applied by an external power source (e.g., a battery) or by exposing a photoactive material to electromagnetic radiation (e.g., sunlight, to produce a photovoltage).

Non-limiting examples of photoactive compositions (or, in some cases, n-type semiconductor materials) include TiO₂, WO₃, SrTiO₃, TiO₂—Si, BaTiO₃, LaCrO₃—TiO₂, LaCrO₃—RuO₂, TiO₂—In₂O₃, GaAs, GaP, p-GaAs/n-GaAs/pGa_{0.2}In_{0.48}P, AlGaAs/SiRuO₂, PbO, FeTiO₃, KTaO₃, MnTiO₃, SnO₂, Bi₂O₃, Fe₂O₃ (including hematite), ZnO, CdS, MoS₂, CdTe, CdSe, CdZnTe, ZnTe, HgTe, HgZnTe, HgSe, ZnTe, ZnS, HgCdTe, HgZnSe, etc., or composites thereof. In some cases, the photoactive composition may be doped. For example, TiO₂ may be doped with Y, V, Mo, Cr, Cu, Al, Ta, B, Ru, Mn, Fe, Li, Nb, In, Pb, Ge, C, N, S, etc., and SrTiO₃ may be doped with Zr. The photoactive composition may be provided in any suitable morphology or arrangement, for example, including single crystal wafers, coatings (e.g., thin films), nanostructured arrays, nanowires, etc. Those of ordinary skill in the art will be aware of methods and techniques for preparing a photoactive composition in a chosen form. For example, doped TiO₂ may be prepared by sputtering, sol-gel, and/or anodization of Ti. In some cases, the semiconductor material may comprise more than one type of semiconductor material. For example, the semiconductor material may comprise one or more of each of an n-type, an i-type, and/or a p-type semiconductor material, to form, for example, a multi-junction cell (e.g., double junction cell, triple junction cell). A non-limiting example of a triple junction cell is a silicon triple junction cell.

In an exemplary embodiment, the photoactive composition may comprise alpha-Fe₂O₃, also known as hematite. In some embodiments, hematite may be doped, for example, with Nb, Si, or In. Hematite has a band gap of about 2 eV and in some cases, has been found to absorb about 40% of the solar flux at ground level. Hematite may be provided in any suitable arrangement, for example, as a single crystal, as a coating (e.g., film) on a surface of a material (e.g., SnO₂ glass, Ti, etc.), as nanowires (e.g., on a material), etc.

The current collector may be transparent, semi-transparent, semi-opaque, and/or opaque. The current collector may be solid, semi-porous, and/or porous. The current collector may be substantially crystalline or substantially non-crystalline, and/or homogenous or heterogeneous.

The current collector may be of any size or shape. Non-limiting examples of shapes include sheets, cubes, cylinders, hollow tubes, spheres, and the like. The current collector may be of any size, provided that at least a portion of the current collector may be immersed in a solution comprising the anionic species. The methods described herein are particularly amenable to forming the catalytic material on any shape and/or size of current collector. In some cases, the maximum dimension of the current collector in one dimension may be at least about 1 mm, at least about 1 cm, at least about 5 cm, at least abut 10 cm, at least about 1 m, at least about 2 m, or greater. In some cases, the minimum dimension of the current collector in one dimension may be less than about 50 cm, less than about 10 cm, less than about 5 cm, less than about 1 cm, less than about 10 mm, less than about 1 mm, less than about 1 um, less than about 100 nm, less than about 10 nm, less than about 1 nm, or less. Additionally, the current collector may comprise a means to connect the current collector to power source and/or other electrical devices. In some cases, the current collector may be at least about 10%, at least about 30%, at least about 50%, at least about 60%, at least about 70%, at least about 80%, at least about 90%, at least about 95%, at least about 100% immersed in a solution comprising anionic species.

The current collector may or may not be substantially planar. For example, the current collector may comprise ripples, waves, dendrimers, spheres (e.g., nanospheres), rods (e.g., nanorods), a powder, a precipitate, a plurality of particles, and the like. In some embodiments, the surface of the current collector may be undulating, wherein the distance between the undulations and/or the height of the undulations are on a scale of nanometers, micrometers, millimeters, centimeters, or the like. In some instances, the planarity of the current collector may be determined by determining the roughness of the current collector, as will be understood by those of ordinary skill in the art.

In some cases, the current collector comprises at least one material that may be susceptible to poisoning or other processes which can affect the operation ability of the material (e.g., a semiconductor material). That is, the methods of the present invention may reduce or prevent the poisoning or other processes from affecting the susceptible material, thus prolonging the life and/or increasing the stability of the material. For example, the current collector may comprise a material which is susceptible to decomposition or poisoning mechanisms upon exposure to water. Accordingly, a catalytic material could not be associated with the electrode via methods that comprise submersing the material in water as the material would be affected. However, when employing a method of the present invention, the current collector could comprise the material substantially coated with a metallic species. Therefore, when the current collector is immersed in water, the material would be protected by the coating of the metallic species.

The current collector comprising the metallic species may be prepared using techniques known to those of ordinary skill in the art. In some embodiments, a film of the metallic species may be formed on a core material using sputtering techniques (e.g., RF sputtering, diode sputtering, magnetron sputtering, DC sputtering, bias sputtering), to electroplating, evaporation, plasma-vapor deposition, cathodic-arc deposition, sputtering, ion implantation, electrostatically, electrochemically, a combination of the above

In some cases, at least a portion of the current collector may be associated with a material to aid in preventing the oxidized metallic species from dispersing into solution during application of a voltage. For example, a portion of the current collector comprising the metallic species may be masked with a masking lacquer. In some cases, the masking lacquer may be position at the air-water interface of the current collector in an electrochemical cell. The masking lacquer, during the application of electrical bias to the current collector, may prevent or reduce the portion of the metallic species which may otherwise disperse into solution at the air-water meniscus. Without wishing to be bound by theory, the dispersion of metallic species into solution may occur because fluctuations present at the interface results in the shuttling of oxidized metallic species away from the current collector faster than they associate with an anionic species to form a catalytic material. Masking lacquers (or stop-off lacquers) will be known to those of ordinary skill in the art and are commercially available. Non-limiting example of masking lacquers include Microstop lacquer, polyesters, acrylic, wax, parylenes, etc.

Selection of metallic species and anionic species for use in the invention will now be described in greater detail. It is to be understood that any of a wide variety of such species meeting the criteria described herein can be used and, so long as they participate in catalytic reactions described herein, they need not necessarily behave, in terms of their oxidation/reduction reactions etc., in the manner described in the application. But in many cases, metal ionic and anionic species selected as described herein, do behave according to one or more of the oxidations/reduction and solubility theories described herein.

Without wishing to be bound by theory, the solubility of a material comprising anionic species and metallic species may influence the association of the metallic species and/or anionic species with the current collector. For example, if a material formed by (c) number of anionic species and (b) number of metallic species is substantially insoluble in the solution, the material may be influenced to associate with the current collector. This non-limiting example may be expressed according to Equation 4:

b(M⁽ⁿ⁾)+c(A^{-y}) [symbol] {[M]_{b}[A]_{c}}^{(b(n)-c(y))}(s) (4)

where M⁽ⁿ⁾ is an oxidized metallic species, A^{-y} is the anionic species, and {[M]_{b}[A]_{c}}^{(b(n)-c(y))} is at least a portion of catalytic material formed, where b and c are the number of to metallic species and anionic species, respectively. The oxidized metallic species may be formed by oxidation of the metallic species having an oxidation state of zero to an oxidation state of (n−x), and in some cases, followed by further oxidation to an oxidation state of (n). The equilibrium may be driven towards the formation of the catalytic material by the presence of an increased amount of anionic species. In some cases, the solution surrounding the current collector may comprise an excess of anionic species, as described herein, to drive the equilibrium towards the formation of the catalytic material associated with the current collector. It should be understood, however, that the catalytic material does not necessarily consist essentially of a material defined by the formula {[M]_{b}[A]_{c}}^{(b(n)-c(y))}, as, in most cases, additional components can be present in the catalytic material (e.g., a second type of anionic species). However, the guidelines described herein (e.g., regarding Kₛₚ) provide information to select complimentary anionic species and metallic species that may aid in the formation and/or stabilization of the catalytic material. In some cases, the catalytic material may comprise at least one bond between a metallic species in an oxidation state greater than zero and an anionic species (e.g., a bond between a cobalt ion and an anionic species comprising phosphorus).

The solubility product constant, Kₛₚ, as will be known to those of ordinary skill in the art, is a simplified equilibrium constant defined for the equilibria between a composition comprising the species and their respective ions in solution and may be defined according to Equation 6, based on the equilibrium shown in Equation 5.

{M_{y}Aₙ}₍s) [symbol] y(M)ⁿ_{(aq)}+n(A)^{-y}_{(aq)} (5)

Kₛₚ=[M]^{y}[A]ⁿ (6)

In Equations 5 and 6, M is the metallic species with a charge of (n), A is the anionic species with a charge of (−y). The solid complex M_{y}Aₙ may disassociate into solubilized metallic species and anionic species. Equation 6 shows the solubility product constant expression. As will be known to those of ordinary skill in the art, the solubility product constant value may change depending on the selected solution and conditions (e.g., temperature, composition, pH, etc.). Therefore, when choosing metallic species and anionic species for the formation of an electrode, the solubility product constant should be determined under the conditions which the electrode is to be formed and/or operated in.

In many cases, the metallic species and anionic species are selected together, for example, such that a composition comprising the metallic species with an oxidation state of (n−x) and the anionic species is soluble in an aqueous solution, the composition having a solubility product constant which is greater than the solubility product constant of a composition comprising the metallic species with an oxidation state of (n) and the anionic species. That is, the composition comprising the metallic species with an oxidation state of (n−x) and the anionic species may have a Kₛₚ value substantially greater than the Kₛₚ for the composition comprising the metallic species with an oxidation state of (n) and the anionic species. For example, the metallic species and anionic species may be selected such that the Kₛₚ value of composition comprising the anionic species and the metallic species with an oxidation state of (n−x) (e.g., M^{(n-x)}) is greater than the Kₛₚ value of the composition comprising the anionic species and the metallic species with an oxidation state of (n) (e.g., M⁽ⁿ⁾) by a factor of at least about 10, at least about 10², at least about 10³, at least about 10⁴, at least about 10⁵, at least about 10⁶, at least about 10⁸, at least about 10¹⁰, at least about 10¹⁵, at least about 10²⁰, at least about 10³⁰, at least about 10⁴⁰, at least about 10⁵⁰, and the like. Where these Kₛₚ values are realized, a catalytic material may be more likely to serve as an electrode or current collector-associated material.

In some instances, a catalytic material, such as a composition comprising a metallic species with an oxidation state of (n) and an anionic species may have a Kₛₚ between about 10⁻³ and about 10⁻⁵⁰. In some cases, the solubility constant of this composition may be between about 10⁻⁴ and about 10⁻⁵⁰, between about 10⁻⁵ and about 10⁻⁴⁰, between about 10⁻⁶ and about 10⁻³⁰, between about 10⁻³ and about 10⁻³⁰, between about 10⁻³ and about 10⁻²⁰, and the like. In some cases, the solubility constant may be less than about 10⁻³, less than about 10⁻⁴, less than about 10⁻⁶, less than about 10⁻⁸, less than about 10⁻¹⁰, less than about 10⁻¹⁵, less than about 10⁻²⁰, less than about 10⁻²⁵, less than about 10⁻³⁰, less than about 10⁻⁴⁰, less than about 10⁻⁵⁰, and the like. In some cases, the composition comprising metallic species with an oxidation state of (n) and the anionic species may have a solubility product constant greater than about 10⁻³, greater than about 10⁻⁴, greater than about 10⁻⁵, greater than about 10⁻⁶, greater than about 10⁻⁸, greater than about 10⁻¹², greater than about 10⁻¹⁵, greater than about 10⁻¹⁸, greater than about 10⁻²⁰, and the like. In a particular embodiment, the composition comprising metallic species and the anionic species may be selected such that the composition comprising the metallic species with an oxidation state of (n) and the anionic species have a Kₛₚ value between about 10⁻³ and about 10⁻¹⁰ and the composition comprising the metallic species with an oxidation state of (n) and the anionic species have a Kₛₚ value less than about 10⁻¹⁰. Non-limiting examples of metallic species and anionic species combinations that may operate as described herein include Co(H)/HPO₄⁻², Co/H₂BO₃⁻, Co/HAsO₄⁻², Fe/CO₃⁻², Mn/CO₃⁻², and Ni/H₂BO₃⁻. In some cases, these combinations may additionally comprise at least a second type of anionic species, for example, oxide and/or hydroxide ions. The composition that forms on the current collector may comprise the metallic species and anionic species selected, as well as additional components (e.g., oxygen, water, hydroxide, counter cations, counter anions, etc.).

Metallic species useful as one portion of a catalytic material of the invention may be any metal selected according to the guidelines described herein. In most embodiments, the metallic species have access to oxidation states of at least zero, (n−x), and (n). In some cases, the metallic species have access to oxidation states of zero, (n−2), (n−1), and/or (n). (n) may be any whole number, and includes, but is not limited to, 0, 1, 2, 3, 4, 5, 6, 7, 8, and the like. In particular embodiments, (n) is 2, 3, or 4. (x) may be any whole number and includes, but is not limited to 0, 1, 2, 3, 4, and the like. In particular embodiments, (x) is 1, 2, or 3. Non-limiting examples of metallic species include Sc, Ti, V, Cr, Mn, Fe, Co, Ni, Cu, Y, Zr, Nb, Mo, Tc, Rh, Ru, Ag, Cd, Pt, Pd, Ir, Hf, Ta, W, Re, Os, Hg, and the like. In some cases, the metallic species may be a lanthanide or actinide (e.g., Ce, Pr, Nd, Sm, Eu, Gd, Tb, Dy, Ho, Er, Tm, Yb, Lu, Th, Pa, U, etc.). In a particular embodiment, the metallic species comprises cobalt, which may be provided as cobalt metal.

An anionic species selected for use with the present invention may be any anionic species that is able to interact with the metallic species in an oxidation state greater than zero as described herein and to meet threshold catalytic requirements as described. In some cases, the anionic compound may be able to accept and/or donate hydrogen ions, for example, H₂PO₄⁻ or HPO₄⁻². Non-limiting examples of anionic species include forms of phosphate (H₃PO₄ or HPO₄⁻², H₂PO₄⁻² or PO₄⁻³), forms of sulphate (H₂SO₄ or HSO₄⁻, SO₄⁻²), forms of carbonate (H₂CO₃ or HCO₃⁻, CO₃⁻²), forms of arsenate (H₃AsO₄ or HAsO₄⁻², H₂AsO₄⁻² or AsO₄⁻³), forms of phosphite (H₃PO₃ or HPO₃⁻², H₂PO₃⁻² or PO₃⁻³), forms of sulphite (H₂SO₃ or HSO₃⁻, SO₃⁻²), forms of silicate, forms of borate (e.g., H₃BO₃, H₂BO₃⁻, HBO₃⁻², etc.), forms of nitrates, forms of nitrites, and the like.

In some cases, the anionic species may be a form of phosphonate. A phosphonate is a compound comprising the structure PO(OR¹)(OR²)(R³) wherein R¹, R², and R³ can be the same or different and are H, an alkyl, an alkenyl, an alkynyl, a heteroalkyl, a heteroalkenyl, a heteroalkynyl, an aryl, or a heteroaryl, all optionally substituted, or are optionally absent (e.g., such that the compound is an anion, dianion, etc.). In a particular embodiment, R¹, R², and R³ can be the same or different and are H, alkyl, or aryl, all optionally substituted. A non-limiting example of a phosphonate is a form of PO(OH)₂R¹ (e.g., PO₂(OH)(R¹)⁻, PO₃(R¹)⁻²), wherein R¹ is as defined above (e.g., alkyl such as methyl, ethyl, propyl, etc.; aryl such as phenol, etc.). In a particular embodiment, the phosphonate may be a form of methyl phosphonate (PO(OH)₂Me), or phenyl phosphonate (PO(OH)₂Ph). Other non-limiting examples of phosphorus-containing anionic species include forms of phosphinites (e.g., P(OR¹)R²R³) and phosphonites (e.g., P(OR¹)(OR²)R³) wherein R¹, R², and R³ are as described above. In other cases, the anionic species may comprise one any form of the following compounds: R¹SO₂(OR²)), SO(OR¹)(OR²), CO(OR¹)(OR²), PO(OR¹)(OR²), AsO(OR¹)(OR²)(R³), wherein R¹, R², and R³ are as described above. With respect to the anionic species discussed above, those of ordinary skill in the art will be able to determine appropriate substituents for the anionic species. The substituents may be chosen to tune the properties of the catalytic material and reactions associated with the catalytic material. For example, the substituent may be selected to alter the solubility constant of a composition comprising the anionic species and the metallic species. Non-limiting examples of anionic species comprising phosphorus include H₃PO₄, H₂PO₄⁻, HPO₄⁻², PO₄⁻³, H₃PO₃, H₂PO₃⁻, HPO₃⁻², PO₃⁻³, R¹PO(OH)₂, R¹PO₂(OH)⁻, R¹PO₃⁻², or the like, wherein R¹ is H, an alkyl, an alkenyl, an alkynyl, a heteroalkyl, a heteroalkenyl, a heteroalkynyl, an aryl, or a heteroaryl, all optionally substituted.

In some embodiments, the anionic species may be good proton-accepting species. As used herein, a “good proton-accepting species” is a species which acts as a good base at a specified pH level. For example, a species may be a good proton-accepting species at a first pH and a poor proton-accepting species at a second pH. Those of ordinary skill in the art will be able to identify a good base in this context. In some cases, a good base may be a compound in which the pKₐ of the conjugate acid is greater than the pKₐ of the proton donor in solution.

The anionic species may be provided as an anionic compound comprising the anionic species and a counter cation. The counter cation may be any cationic species, for example, a metal ion (e.g., K⁺, Na⁺, Li⁺, Mg⁺², Ca⁺², Sr⁺²), NR₄⁺ (e.g., NH₄⁺), H⁺, and the like. In a specific embodiment, the anionic compound employed may be K₂HPO₄.

The catalytic material may comprise the metallic species and anionic species in a variety of ratios (amounts relative to each other). In some cases, the catalytic material comprises the metallic species and the anionic species in a ratio of less than about 20:1, less than about 15:1, less than about 10:1, less than about 7:1, less than about 6:1, less than about 5:1, less than about 4:1, less than about 3:1, less than about 2:1, greater than about 1:1, greater than about 1:2, greater than about 1:3, greater than about 1:4, greater than about 1:5, greater than about 1:10, and the like. In some cases, the catalytic material may comprise additional components, such as counter cations and/or counter anions from the metallic compound and/or anionic compound provided to the solution. In some instances, the catalytic material may additionally comprise at least one of water, oxygen gas, hydrogen gas, oxygen ions (e.g., O⁻²), peroxide, hydrogen ion (e.g., H⁺), and/or the like.

In some embodiments, a catalytic material of the invention may comprise more than one type of metallic species and/or anionic species (e.g., at least about 2 types, at least about 3 types, at least about 4 types, at least about 5 types, or more, of metallic species and/or anionic species). For example, more than one type anionic species may be provided to the solution in which the current collector is immersed. In such instances, the catalytic material may comprise more than one type of anionic species. Without wishing to be bound by theory, the presence of more than one type of metallic species and/or anionic species may allow for the properties of the catalytic material to be tuned, such that the performance of the electrode may be altered by using combinations of species in different ratios. In a particular embodiment, the current collector may comprise a composition comprising a first type of metallic species (e.g., Co(0)) and second type of metallic species (e.g., Ni(0)), such that the catalytic material formed comprises the first type of metallic species and the second type of metallic species in oxidation states greater than zero (e.g., Co(II)/Co(III)/Co(IV) and Ni(I)/Ni(II)/Ni(III)). In some cases, the catalytic material may comprise a metallic species, in an oxidation state greater than zero a first type of anionic species, and a second type of anionic species. In some instances, the first type of anionic species is hydroxide and/or oxide ions, and the second type of anionic species is not hydroxide and/or oxide ions. Therefore, at least the first type of anionic species or the second type of anionic species is not hydroxide or oxide ions. It should be understood, however, that when at least one type of anionic species is an oxide or hydroxide, the species might not be provided to the solution but instead, may be present in the water or solution the species is provided in and/or may be formed during a reaction (e.g., between the first type of anionic species and the metallic species).

In some embodiments, the catalytic metallic species/anionic species do not consist essentially of metallic species/O⁻² and/or metallic species/Off. A material “consists essentially of” a species if it is made of that species and no other species that significantly alters the characteristics of the material, for purposes of the invention, as compared to the original species in pure form. Accordingly, where a catalytic material does not consist essentially of metallic species/O⁻² and/or metallic species/Off, the catalytic material has characteristics significantly different than a pure metallic species/O⁻² and/or metallic species/Off, or a mixture. In some cases, a composition that does not consist essentially of metallic species/O⁻² and/or metallic species/OH⁻ comprises less than about 90%, less than about 80%, less than about 70%, less than about 60%, less than about 50%, less than about 40%, less than about 30%, less than about 20%, less than about 10%, less than about 5%, less than about 1%, and the like, weight percent of O⁻² and/or OH⁻ ions/molecules. The weight percent of O⁻² and/or OH⁻ ions/molecules may be determined using methods known to those of ordinary skill in the art. For example, the weight percent may be determined by determining the approximate structure of the material comprise in the composition.

In a specific embodiment, the catalytic materials may comprise cobalt ions and anionic species comprising phosphorus (e.g., HPO₄⁻²). In some cases, the composition may additionally comprise cationic species (e.g., K⁺). An anionic species comprising phosphorus may be any molecule that comprises phosphorus and is associated with a negative charge.

Whether the electrode has been properly formed, with proper association of the catalytic material with the current collector, may be important to monitor, both for selecting proper metallic species and/or anionic species and, of course, determining whether an appropriate electrode has been formed. The electrode may be determined to have been formed using various procedures. In some instances, the formation of a catalytic material on the current collector may be observed. The formation of the material may be observed by a human eye, or with use of magnifying devices such as a microscope or via other instrumentation. In one case, application of a voltage to the electrode, in conjunction with an appropriate counter electrode and other components (e.g., circuitry, power source, electrolyte) may be carried out to determine whether the system produces oxygen gas at the electrode when the electrode is exposed to water. In some cases, the minimum voltage applied to the electrode which causes oxygen gas to form at the electrode may be different than the voltage required to form gas from the current collector alone. In some cases, the minimum voltage required for the electrode will be less than the voltage required for the current collector alone (i.e., the overpotential will be less for the electrode that includes both the current collector and catalytic material, than for the current collector alone).

The catalytic material (and/or the electrode comprising the catalytic material) may also be characterized in terms of performance. One way of doing this, among many, is to compare the current density of the electrode versus the current collector alone. The current collector may be able to function, itself, as a catalytic electrode in water electrolysis, and may have been used in the past to do so. So, the current density during catalytic water electrolysis (where the electrode catalytically produces oxygen gas from water), using the current collector, as compared to essentially identical conditions (with the same counter electrode, same electrolyte, same external circuit, same water source, etc.), using the electrode including both current collector and catalytic material, can be compared. In most cases, the current density of the electrode will be greater than the current density of the current collector alone, where each is tested independently under essentially identical conditions. For example, the current density of the electrode may exceed the current density of the current collector by a factor of at least about 10, about 100, about 1000, about 10⁴, about 10⁵, about 10⁶, about 10⁸, about 10¹⁰, and the like. The current density may either be the geometric current density or the total current density, as described herein. In some cases, the current density can be described as the total current density. Total current density, as used herein, is the current density divided by essentially the total surface area (e.g., the total surface area including all pores, fibers, etc.) of the electrode. In some cases, the total current density may be approximately equal to the geometric current density (e.g., in cases where the electrode is not porous and the total surface area is approximately equal to the geometric surface area).

This characteristic, namely, significantly increased catalytic activity of the electrode (comprising a current collector and catalytic material associated with the current collector) as compared to the current collector alone, may be used to monitor formation of a catalytic electrode. That is, the formation of the catalytic material on the current collector may also be observed by monitoring the current density over a period of time. The current density, in most cases, will increase during application of a voltage to the current collector. In some instances, the current density may reach a plateau after a period of time (e.g., about 2 hours, about 4 hours, about 6 hours, about 8 hours, about 10 hours, about 12 hours, about 24 hours, and the like).

In some embodiments, wherein the current collector comprises a photoactive material (e.g., a semiconductor material, in some cases), the energy conversion efficiency of the formed electrode (e.g., photoanode) may be at least about 5%, at least about 10%, at least about 15%, at least about 20%, at least about 30%, at least about 40%, at least about 50%, at least about 60% at least about 70%, at least about 80%, at least about 90%, at least about 100%, at least about 150%, at least about 200%, or greater, than the efficiency of the current collector alone, operated under essentially identical conditions. Energy conversion efficiency is the ratio between the useful output of an energy conversion device and the input, in energy terms and techniques for measuring the efficiency, as will be known to those of ordinary skill in the art. In some cases, the current density of the electrode comprising a photoactive material may be greater than the current density of the photoactive material alone by a factor of at least about 10, about 100, about 1000, about 10⁴, about 10⁵, about 10⁶, about 10⁸, about 10¹⁰, and the like. In some embodiments, the current density of the electrode comprising a photoactive material may exceed the current density of the photoactive material alone by a factor between about 10⁴ and about 10¹⁰, between about 10⁵ and about 10⁹, or between about 10⁴ and about 10⁸.

In embodiments wherein the current collector comprises a photoactive material (e.g., a semiconductor material, in some cases), the incident photon-to-current conversion efficiency (or IPCE, also known as energy quantum efficiency) that is required by the photoanode to produce oxygen gas may be different than the IPCE required by the photoactive material alone. The term “incident photon-to-current conversion efficiency,” as used herein, refers to a measure of the photon to electron conversion efficiency at a specific wavelength. As will be known to those of ordinary skill in the art, IPCE may be determined from measuring the monochromatic light power density, and may be calculated as a function of short circuit current density, incident light power density, and wavelength. In some cases, the IPCE for the electrode is greater than the IPCE for the photoactive material alone. In some embodiments, the IPCE of a electrode is about 1%, about 2%, about 5%, about 10%, about 20%, about 25%, about 30%, about 40%, about 50%, about 75%, about 100%, or more, greater than the IPCE of the photoactive electrode alone. In some cases, the IPCE is measured with solar simulated light (e.g., AM-1.5 illumination).

In some cases, a device (e.g., photoelectrochemical cell) comprising the electrode comprising a photoactive material may be characterized by its overall efficiency for conversion of solar energy to chemical energy. In such embodiments, a photoelectrochemical cell may be illuminated with light (e.g. solar simulated AM 1.5 radiation) to generate a photocurrent. The overall energy conversion efficiency of the device may be determined by Equation 17:

η(%)=100(E−V_{bias})(iₜ)/(PₕᵥA) (17)

wherein η is the overall energy conversion efficiency of the device, E is the Nernstian value for electrolysis of the solution redox species (e.g., conversion of water to hydrogen and oxygen gas), V_{bias} is the voltage across the cell, iₜ is the total current flowing in the device, Pₕᵥ is the power of the incident light radiation, and A is irradiated surface area. V_{bias} is generally defined to be negative if the cell can simultaneously produce electrical power and stored chemical energy, and is generally defined to be positive if an additional power input is needed for the cell to perform the desired electrolysis reaction. In some embodiments, the overall energy conversion efficiency may be less than about 0.1%, less than about 1%, less than about 2%, less than about 5%, less than about 10%, less than about 15%, less than about 18%, less than about 20%, less than about 25%, less than about 30%, less than about 50%, or the like. In some cases, the overall energy conversion efficiency is about 0.1%, about 0.5%, about 1%, about 5%, about 10%, about 15%, about 18%, about 20%, about 25%, about 30%, about 35%, about 40%, about 50%, or the like, or between about 0.1% and about 30%, between about 1% and about 30%, between about 10% and about 50%, between about 10% and about 30%, or any range therein. Those of ordinary skill in the art will be aware of techniques for determining the overall energy conversion efficiency, for example, see Parkinson et al., Acc. Chem. Res. 1984, 17, 431-437.

Electrodes as described herein may be formed prior to incorporation in a functional device (e.g., electrolysis device, fuel cell, or the like) or may be formed during operation of such a device. For example, in some cases, an electrode may be formed using methods described herein. The electrode may then be incorporated into a device (e.g., an electrolytic device). As another example, in some cases, a device may comprise a current collector comprising metallic species in an oxidation state of zero and a solution (e.g., electrolyte) comprising anionic species. Upon operation of the device (e.g., application of a potential between the current collector and a second electrode), a catalytic material (e.g., comprising the metallic species in an oxidation state greater than zero and anionic species from the solution) may associate with the current collector, thereby forming an electrode in the device. After formation of the electrode, the electrode can be used for purposes described herein with or without change in environment (e.g., change in solution or other medium to which the electrode is exposed), depending upon the desired formation and/or use medium, which would be apparent to those of ordinary skill in the art.

In some cases, the catalytic material may associate with the current collector via formation of a bond, such as an ionic bond, a covalent bond (e.g., carbon-carbon, carbon-oxygen, oxygen-silicon, sulfur-sulfur, phosphorus-nitrogen, carbon-nitrogen, metal-oxygen, or other covalent bonds), a hydrogen bond (e.g., between hydroxyl, amine, carboxyl, thiol, and/or similar functional groups), a dative bond (e.g., complexation or chelation between metal ions and monodentate or multidentate ligands), Van der Waals interactions, and the like. “Association” of the composition (e.g., catalytic material) with the current collector would be understood by those of ordinary skill in the art based on this description. In some embodiments, the interaction between a metallic species and an anionic species may comprise an ionic interaction, wherein the metallic species is directly bound to other species and the anionic species is a counterion not directly bound to the metallic species. In a specific embodiment, an anionic species and a metallic species form an ionic bond and the complex formed is a salt.

A catalytic material associated with a current collector will most often be arranged with respect to the current collector so that it is in sufficient electrical communication with the current collector to carry out purposes of the invention as described herein. “Electrical communication,” as used herein, is given its ordinary meaning as would be understood by those of ordinary skill in the art whereby electrons can flow between the current collector and the catalytic material in a facile enough manner for the electrode to operate as described herein. That is, charge may be transferred between the current collector and the catalytic material (e.g., the metallic species and/or anionic species present in the catalytic material). In some embodiments, the catalytic material and the current collector may be integrally connected. The term “integrally connected,” when referring to two or more objects or materials, means objects and/or materials that do not become separated from each other during the course of normal use, e.g., separation requires at least the use of tools, and/or by causing damage to at least one of the components, for example, by breaking, peeling, dissolving, etc. A catalytic material may be considered to be associated with, or otherwise in direct electrical communication with a current collector during operation of an electrode comprising the catalytic material and current collector even in instances where a portion of the catalytic material may be dissociated from the current collector during operation.

The properties of the catalytic material may vary. For example, the catalytic material may be porous, substantially porous, non-porous, and/or substantially non-porous. For example, the pores may comprise a range of sizes, may or might not be substantially uniform in size, and may be open and/or closed pores. In some instances, the catalytic material may be hydrated. That is, the catalytic material may comprise water and/or other liquid and/or gas components. In addition, the physical structure of the catalytic material may vary. For example, the catalytic material may be a film and/or particles associated with at least a portion of the current collector (e.g., surface and/or pores) that is immersed in the solution. The catalytic material may have an appearance of being smooth and/or bumpy. In some cases, the catalytic material may comprise cracks, as can be the case when the material dehydrated.

In some cases, the thickness of catalytic material may be of substantially the same throughout the material. In other cases, the thickness of the catalytic material may vary throughout the material (e.g., a film does not necessarily have uniform thickness). The thickness of the catalytic material may be determined by determining the thickness of the material at a plurality of areas (e.g., at least 2, at least 4, at least 6, at least 10, at least 20, at least 40, at least 50, at least 100, or more areas) and calculating the average thickness. Where thickness of a catalytic material is determined via probing at a plurality of areas, the areas may be selected so as not to specifically represent areas of more or less catalytic material present based upon a pattern. Those of ordinary skill in the art will easily be able to establish a thickness-determining protocol that accounts for any non-uniformity or patterning of catalytic material on the surface. The average thickness of the catalytic material may be at least about or about 1 nm, at least about or about 5 nm, at least about or about 10 nm, at least about or about 20 nm, at least about or about 30 nm, at least about or about 40 nm, at least about or about 50 nm, at least about or about 75 nm, at least about or about 100 nm, at least about or about 300 nm, at least about or about 500 nm, at least about or about 700 nm, at least about or about 1 um (micrometer), at least about or about 2 um, at least about or about 5 um, at least about or about 1 mm, at least about or about 1 cm, and the like. The average thickness of the catalytic material may be varied by altering the amount and length of time a voltage is applied to the current collector, the concentration of the metallic species and the anionic species in solution, the surface area of the current collector, the surface area density of the current collector, and the like.

In some embodiments, the electrodes of the present invention may be used for the catalytic formation of oxygen gas from water. As shown in Equation 1, water may be split to form oxygen gas, electrons, and hydrogen ions. Although it need not be, an electrode of the present invention may be operated in benign conditions (e.g., neutral or near-neutral pH, ambient temperature, ambient pressure, etc.). In some cases, the electrodes described herein operate catalytically. That is, an electrode may be able to catalytically produce oxygen gas from water, but the electrode might not necessarily participate in the related chemical reactions such that it is consumed to any appreciable degree. Those of ordinary skill in the art will understand the meaning of “catalytically” in this context. An electrode may also be used for the catalytic production of other gases and/or materials.

In some embodiments, an electrode as described herein may be capable of producing oxygen gas from water at a low overpotential. Voltage in addition to a thermodynamically determined reduction or oxidation potential that is required to attain a given catalytic activity is herein referred to as “overpotential,” and may limit the efficiency of the electrolytic device. Overpotential is therefore given its ordinary meaning in the art, that is, it is the potential that must be applied to a system, or a component of a system such as an electrode to bring about an electrochemical reaction (e.g., formation of oxygen gas from water) minus the thermodynamic potential required for the reaction. Those of ordinary skill in the art understand that the total potential that must be applied to a particular system in order to drive a reaction can typically be the total of the potentials that must be applied to the various components of the system. For example, the potential for an entire system can typically be higher than the potential as measured at, e.g., an electrode at which oxygen gas is produced from the electrolysis of water. Those of ordinary skill in the art will recognize that where overpotential for oxygen production from water electrolysis is discussed herein, this applies to the voltage required for the conversion of water to oxygen itself, and does not include voltage drop at the counter electrode. The thermodynamic potential for the production of oxygen gas from water varies depending on the conditions of the reaction (e.g., pH, temperature, pressure, etc.). Those of ordinary skill in the art will be able to determine the required thermodynamic potential for the production of oxygen gas from water depending on the experimental conditions.

In some instances, an electrode as described herein may be capable of catalytically producing oxygen gas from water (e.g., gaseous and/or liquid water) with an overpotential of less than about 1 volt, less than about 0.75 volts, less than about 0.5 volts, less than about 0.4 volts, less than about 0.35 volts, less than about 0.325 volts, less than about 0.3 volts, less than about 0.25 volts, less than about 0.2 volts, less than about 0.1 volts, or the like. In some embodiments, the overpotential is between about 0.1 volts and about 0.4 volts, between about 0.2 volts and about 0.4 volts, between about 0.25 volts and about 0.4 volts, between about 0.3 volts and about 0.4 volts, between about 0.25 volts and about 0.35 volts, or the like. In some cases, the overpotential of an electrode is determined under standardized conditions of an electrolyte with a neutral pH (e.g., about pH 7.0), ambient temperature (e.g., about 25° C.), ambient pressure (e.g., about 1 atm), a current collector that is non-porous and planar (e.g., an ITO plate), and at a geometric current density (as described herein) of about 1 mA/cm².

In some embodiments, an electrode may be capable of catalytically producing oxygen gas from water (e.g., gaseous and/or liquid water) with a Faradaic efficiency of about 100%, greater than about 99.8%, greater than about 99.5%, greater than about 99%, greater than about 98%, greater than about 97%, greater than about 96%, greater than about 95%, greater than about 90%, greater than about 85%, greater than about 80%, greater than about 70%, greater than about 60%, greater than about 50%, etc. The term, “Faradaic efficiency,” as used herein, is given its ordinary meaning in the art and refers to the efficacy with which charge (e.g., electrons) are transferred in a system facilitating an electrochemical reaction. Loss in Faradaic efficiency of a system may be caused, for example, by the misdirection of electrons which may participate in unproductive reactions, product recombination, short circuit the system, and other diversions of electrons and may result in the production of heat and/or chemical byproducts. Those of ordinary skill in the art will be aware of methods and systems for determining Faradaic efficient (e.g., through bulk electrolysis where a known quantity of reagent is stoichiometrically converted to product as measured by the current passed and this quantity may be compared to the observed quantity of product measured through another analytical method).

In some embodiments, systems and/or devices may be provided that comprise an electrode described above and/or an electrode prepared using the above described methods. In particular, a device may be an electrochemical device (e.g., an energy conversion device). Non-limiting examples of electrochemical devices includes electrolytic devices, fuel cells, and regenerative fuel cells, as described herein. In some embodiments, the device is an electrolytic device. An electrolytic device may function as an oxygen gas and/or hydrogen gas generator by electrolytically decomposing water (e.g., liquid and/or gaseous water) to produce oxygen and/or hydrogen gases. In certain arrangements, electrochemical devices may be employed to both convert electricity and water into hydrogen and oxygen gases, and hydrogen and oxygen gases back into electricity and water as needed. Such systems are commonly referred to as regenerative fuel cell systems. The fuel may be provided to a device in a solid, liquid, gel, and/or gaseous state. Electrolytic devices and fuel cells are structurally similar, but are utilized to effect different half-cell reactions. An energy conversion device, in some embodiments, may be used to provide at least a portion of the energy required to operate an automobile, a house, a village, a cooling device (e.g., a refrigerator), etc. In some cases, more than one device may be employed to provide the energy. Other non-limiting examples of device uses include O₂ production (e.g., gaseous oxygen), H₂ production (e.g., gaseous hydrogen), H₂O₂ production, ammonia oxidation, hydrocarbon (e.g., methanol, methane, ethanol, and the like) oxidation, exhaust treatment, etc.

In some embodiments, a device and/or electrode as described herein is capable of producing at least about 1 umol (micromole), at least about 5 umol, at least about 10 to umol, at least about 20 umol, at least about 50 umol, at least about 100 umol, at least about 200 umol, at least about 500 umol, at least about 1000 umol oxygen and/or hydrogen, or more, per cm² at the electrode at which oxygen production or hydrogen production occurs, respectively, per hour. The area of the electrode may be the geometric surface area or the total surface area, as described herein.

Individual aspects of the overall electrochemistry and/or chemistry, and electrochemical devices will be known to those of ordinary skill in the art. Various components of a device, such as the electrodes, power source, electrolyte, separator, container, circuitry, insulating material, gate electrode, etc. can be fabricated and/or selected by those of ordinary skill in the art from any of a variety of components, as well as those described in any of those patent applications described herein. Components may be molded, machined, extruded, pressed, isopressed, infiltrated, coated, in green or fired states, or formed by any other suitable technique. Those of ordinary skill in the art are readily aware of techniques for forming components of devices herein. Water may be provided to the systems, devices, electrodes, and/or for the methods described herein using any suitable source. In some embodiments, the water may contain at least one impurity (e.g., NaCl). In some cases, an electrolytic device may be constructed and arranged to be electrically connectable to and able to be driven by the photovoltaic cell (e.g., the photovoltaic cell may be the power source for the device for the electrolysis of water). A devices and methods as described herein, in some cases, may proceed at about ambient conditions. Ambient conditions define the temperature and pressure relating to the device and/or method. For example, ambient conditions may be defined by a temperature of about 25° C. and a pressure of about 1.0 atmosphere (e.g., 1 atm, 14 psi). In some cases, the conditions may be essentially ambient. Ambient or essentially ambient conditions can be used in conjunction with any of the devices, compositions, catalytic materials, and/or methods described herein, in conjunction with any conditions (for example, conditions of pH, etc.). In some cases, however, the devices and/or methods as described herein may proceed at temperatures above or below ambient temperature.

An electrolyte, as known to those of ordinary skill in the art is any substance containing free ions that is capable of functioning as an ionically conductive medium. In some cases, an electrolyte may comprise water, which may act as the water source. The electrolyte may be a liquid, a gel, and/or a solid. In some cases, the pH of the electrolyte may be about neutral. That is, the pH of the electrolyte may be between about 5.5 and about 8.5, between about 6.0 and about 8.0, about 6.5 about 7.5, and/or the pH is about 7.0. In a particular case, the pH is about 7.0. In other cases, the pH of the electrolyte is about neutral or basic. In some cases, when the electrolyte is a solid, the electrolyte may comprise a solid polymer electrolyte. The solid polymer electrolyte may serve as a solid electrolyte that conducts protons and separate the gases produces and or utilized in the electrochemical cell. Non-limiting examples of a solid polymer electrolyte are polyethylene oxide, polyacrylonitrile, and commercially available NAFION.

Electromagnetic radiation may be provided by any suitable source. For example, electromagnetic radiation may be provided by sunlight and/or an artificial light source. In an exemplary embodiment, the electromagnetic radiation is provided by sunlight. In some embodiments, light may be provided by sunlight at certain times of operation of a device (e.g., during daytime, on sunny days, etc.) and artificial light may be used at other times of operation of the device (e.g., during nighttime, on cloudy days, etc.). Non-limiting examples of artificial light sources include a lamp (mercury-arc lamp, a xenon-arc lamp, a quartz tungsten filament lamp, etc.), a laser (e.g., argon ion), and/or a solar simulator. The spectra of the artificial light source may be substantially similar or substantially different than the spectra of natural sunlight. The light provided may be infrared (wavelengths between about 1 mm and about 750 nm), visible (wavelengths between about 380 nm and about 750 nm), and/or ultraviolet (wavelengths between about 10 nm and about 380 nm). In some cases, the electromagnetic radiation may be provided at a specific wavelength, or specific ranges of wavelengths, for example, through use of a monochromatic light source or through the use of filters. The power of the electromagnetic radiation may also be varied. For example, the light source provided may have a power of at least about 100 W, at least about 200 W, at least about 300 W, at least about 500 W, at least about 1000 W, or greater.

The catalytic materials formed on the current collector, in some embodiments, may comprise metallic species and anionic species as described in the following references, herein incorporated by reference: U.S. Publication No. 2010/0101955, published Apr. 29, 2010, entitled “Catalytic Materials, Electrodes, and Systems for Water Electrolysis and Other Electrochemical Techniques,” by Nocera, et al., U.S. Publication No. 2010/0133110, published Jun. 2, 2010, entitled “Catalytic Materials, Photoanodes, and Photoelectrochemical Cells For Water Electrolysis and Other Electrochemical Techniques,” by Nocera, et al., and U.S. Publication No. 2010/0133111, published Jun. 2, 2010, entitled “Catalytic Materials, Photoanodes, and Photoelectrochemical Cells For Water Electrolysis and Other Electrochemical Techniques,” by Nocera, et al. These references also describe in more detail aspects of the mechanism, operation, and other components of the catalytic materials and electrochemical devices as described herein.

A variety of definitions are now provided which may aid in understanding various aspects of the invention.

The term “catalytic material” as used herein, means a material that is involved in and increases the rate of a chemical electrolysis reaction (or other electrochemical reaction) and which, itself, undergoes reaction as part of the electrolysis, but is largely unconsumed by the reaction itself, and may participate in multiple chemical transformations. A catalytic material may also be referred to as a catalyst and/or a catalyst composition. A catalytic material is not simply a bulk current collector material which provides and/or receives electrons from an electrolysis reaction, but a material which undergoes a change in chemical state of at least one ion during the catalytic process. For example, a catalytic material might involve a metal center which undergoes a change from one oxidation state to another during the catalytic process. Thus, catalytic material is given its ordinary meaning in the field in connection with this invention. As will be understood from other descriptions herein, a catalytic material of the invention that may be consumed in slight quantities during some uses and may be, in many embodiments, regenerated to its original chemical state.

The term “catalytic electrode” is a current collector, in addition to any catalytic material adsorbed thereto or otherwise provided in electrical communication with (as defined herein) the current collector. The catalytic material may comprise metallic species and anionic species (and/or other species), wherein the metallic species and anionic species are associated with the current collector. The metallic species and anionic species may be selected such that, when exposed to an aqueous solution (e.g., an electrolyte or water source), the metallic species and anionic species may associate with the current collector though a change in oxidation state of the metallic species. Where “electrode” is used herein to describe what those of ordinary skill in the art would understand to be the “catalytic electrode,” it is to be understood that a catalytic electrode as defined above is intended.

The term “electrolysis,” as used herein, refers to the use of an electric current to drive an otherwise non-spontaneous chemical reaction. For example, in some cases, electrolysis may involve a change in redox state of at least one species and/or formation and/or breaking of at least one chemical bond, by the application of an electric current. Electrolysis of water, as provided by the invention, can involve splitting water into oxygen gas and hydrogen gas, or oxygen gas and another hydrogen-containing species, or hydrogen gas and another oxygen-containing species, or a combination. In some embodiments, devices of the present invention are capable of catalyzing the reverse reaction. That is, a device may be used to produce energy from combining hydrogen and oxygen gases (or other fuels) to produce water.

In general, the term “aliphatic,” as used herein, includes both saturated and unsaturated, straight chain (i.e., unbranched) or branched aliphatic hydrocarbons, which are optionally substituted with one or more functional groups, as defined below. As will be appreciated by one of ordinary skill in the art, “aliphatic” is intended herein to include, but is not limited to, alkyl, alkenyl, alkynyl moieties. Illustrative aliphatic groups thus include, but are not limited to, for example, methyl, ethyl, n-propyl, isopropyl, allyl, n-butyl, sec-butyl, isobutyl, tert-butyl, n-pentyl, sec-pentyl, isopentyl, tert-pentyl, n-hexyl, sec-hexyl, moieties and the like, which again, may bear one or more substituents, as previously defined.

As used herein, the term “alkyl” is given its ordinary meaning in the art and may include saturated aliphatic groups, including straight-chain alkyl groups, branched-chain alkyl groups, cycloalkyl (alicyclic) groups, alkyl substituted cycloalkyl groups, and cycloalkyl substituted alkyl groups. An analogous convention applies to other generic terms such as “alkenyl,” “alkynyl,” and the like. Furthermore, as used herein, the terms “alkyl,” “alkenyl,” “alkynyl,” and the like encompass both substituted and unsubstituted groups.

In some embodiments, a straight chain or branched chain alkyl may have 30 or fewer carbon atoms in its backbone, and, in some cases, 20 or fewer. In some embodiments, a straight chain or branched chain alkyl has 12 or fewer carbon atoms in its backbone (e.g., C₁-C₁₂ for straight chain, C₃-C₁₂ for branched chain), has 6 or fewer, or has 4 or fewer. Likewise, cycloalkyls have from 3-10 carbon atoms in their ring structure or from 5, 6 or 7 carbons in the ring structure. Examples of alkyl groups include, but are not limited to, methyl, ethyl, propyl, isopropyl, cyclopropyl, butyl, isobutyl, tert-butyl, cyclobutyl, hexyl, cyclohexyl, and the like. In some cases, the alkyl group might not be cyclic. Examples of non-cyclic alkyl include, but are not limited to, methyl, ethyl, propyl, isopropyl, n-butyl, tert-butyl, n-pentyl, neopentyl, n-hexyl, n-heptyl, n-octyl, n-decyl, n-undecyl, and dodecyl.

The terms “alkenyl” and “alkynyl” refer to unsaturated aliphatic groups analogous in length and possible substitution to the alkyls described above, but that contain at least one double or triple bond respectively. Alkenyl groups include, but are not limited to, for example, ethenyl, propenyl, butenyl, 1-methyl-2-buten-1-yl, and the like. Non-limiting examples of alkynyl groups include ethynyl, 2-propynyl (propargyl), 1-propynyl, and the like.

The terms “heteroalkenyl” and “heteroalkynyl” refer to unsaturated aliphatic groups analogous in length and possible substitution to the heteroalkyls described above, but that contain at least one double or triple bond respectively.

As used herein, the term “halogen” or “halide” designates —F, —Cl, —Br, or —I. The term “aryl” refers to aromatic carbocyclic groups, optionally substituted, having a single ring (e.g., phenyl), multiple rings (e.g., biphenyl), or multiple fused rings in which at least one is aromatic (e.g., 1,2,3,4-tetrahydronaphthyl, naphthyl, anthryl, or phenanthryl). That is, at least one ring may have a conjugated Pi electron system, while other, adjoining rings can be cycloalkyls, cycloalkenyls, cycloalkynyls, aryls, and/or heterocycyls. The aryl group may be optionally substituted, as described herein. “Carbocyclic aryl groups” refer to aryl groups wherein the ring atoms on the aromatic ring are carbon atoms. Carbocyclic aryl groups include monocyclic carbocyclic aryl groups and polycyclic or fused compounds (e.g., two or more adjacent ring atoms are common to two adjoining rings) such as naphthyl group. Non-limiting examples of aryl groups include phenyl, naphthyl, tetrahydronaphthyl, indanyl, indenyl and the like.

The terms “heteroaryl” refers to aryl groups comprising at least one heteroatom as a ring atom, such as a heterocycle. Non-limiting examples of heteroaryl groups include pyridyl, pyrazinyl, pyrimidinyl, pyrrolyl, pyrazolyl, imidazolyl, thiazolyl, oxazolyl, isooxazolyl, thiadiazolyl, oxadiazolyl, thiophenyl, furanyl, quinolinyl, isoquinolinyl, and the like.

It will also be appreciated that aryl and heteroaryl moieties, as defined herein, may be attached via an aliphatic, alicyclic, heteroaliphatic, heteroalicyclic, alkyl or heteroalkyl moiety and thus also include -(aliphatic)aryl, -(heteroaliphatic)aryl, -(aliphatic)heteroaryl, -(heteroaliphatic)heteroaryl, -(alkyl)aryl, -(heteroalkyl)aryl, -(heteroalkyl)aryl, and -(heteroalkyl)-heteroaryl moieties. Thus, as used herein, the phrases “aryl or heteroaryl” and “aryl, heteroaryl, (aliphatic)aryl, -(heteroaliphatic)aryl, -(aliphatic)heteroaryl, -(heteroaliphatic)heteroaryl, -(alkyl)aryl, -(heteroalkyl)aryl, -(heteroalkyl)aryl, and -(heteroalkyl)heteroaryl” are interchangeable.

Any of the above groups may be optionally substituted. As used herein, the term “substituted” is contemplated to include all permissible substituents of organic compounds, “permissible” being in the context of the chemical rules of valence known to those of ordinary skill in the art. It will be understood that “substituted” also includes that the substitution results in a stable compound, e.g., which does not spontaneously undergo transformation such as by rearrangement, cyclization, elimination, etc. In some cases, “substituted” may generally refer to replacement of a hydrogen with a substituent as described herein. However, “substituted,” as used herein, does not encompass replacement and/or alteration of a key functional group by which a molecule is identified, e.g., such that the “substituted” functional group becomes, through substitution, a different functional group. For example, a “substituted phenyl group” must still comprise the phenyl moiety and can not be modified by substitution, in this definition, to become, e.g., a pyridine ring. In a broad aspect, the permissible substituents include acyclic and cyclic, branched and unbranched, carbocyclic and heterocyclic, aromatic and nonaromatic substituents of organic compounds. Illustrative substituents include, for example, those described herein. The permissible substituents can be one or more and the same or different for appropriate organic compounds. For purposes of this invention, the heteroatoms such as nitrogen may have hydrogen substituents and/or any permissible substituents of organic compounds described herein which satisfy the valencies of the heteroatoms.

Examples of substituents include, but are not limited to, aliphatic, alicyclic, heteroaliphatic, heteroalicyclic, halogen, azide, alkyl, aralkyl, alkenyl, alkynyl, cycloalkyl, hydroxyl, alkoxyl, amino, nitro, sulfhydryl, imino, amido, phosphonate, phosphinate, carbonyl, carboxyl, silyl, ether, alkylthio, heteroalkylthio, heteroarylthio, sulfonyl, sulfonamido, ketone, aldehyde, ester, heterocyclyl, aromatic or heteroaromatic moieties, —CF₃, —CN, aryl, aryloxy, perhaloalkoxy, aralkoxy, heteroaryl, heteroaryloxy, heteroarylalkyl, heteroaralkoxy, azido, amino, halide, alkylthio, oxo, acylalkyl, carboxy esters, -carboxamido, acyloxy, aminoalkyl, alkylaminoaryl, alkylaryl, alkylaminoalkyl, alkoxyaryl, arylamino, aralkylamino, alkylsulfonyl, -carboxamidoalkylaryl, -carboxamidoaryl, hydroxyalkyl, haloalkyl, alkylaminoalkylcarboxy-, aminocarboxamidoalkyl-, cyano, alkoxyalkyl, perhaloalkyl, arylalkyloxyalkyl, (e.g., SO₄(R′)₂), a phosphate (e.g., PO₄(R′)₃), a silane (e.g., Si(R)₄), a urethane (e.g., R′O(CO)NHR′), and the like. Additionally, the substituents may be selected from F, Cl, Br, I, —OH, —NO₂, —CN, —NCO, —CF₃, —CH₂CF₃, —CHCl₂, —CH₂ORₓ, —CH₂CH₂ORₓ, —CH₂N(Rₓ)₂, —CH₂SO₂CH₃, —C(O)Rₓ, —CO₂(Rₓ), —CON(Rₓ)₂, —OC(O)Rₓ, —C(O)OC(O)Rₓ, —OCO₂Rₓ, —OCON(Rₓ)₂, —N(Rₓ)₂, —S(O)₂Rₓ, —OCO₂Rₓ, —NRₓ(CO)Rₓ, —NRₓ(CO)N(Rₓ)₂, wherein each occurrence of Rₓ independently includes, but is not limited to, H, aliphatic, alicyclic, heteroaliphatic, heteroalicyclic, aryl, heteroaryl, alkylaryl, or alkylheteroaryl, wherein any of the aliphatic, alicyclic, heteroaliphatic, heteroalicyclic, alkylaryl, or alkylheteroaryl substituents described above and herein may be substituted or unsubstituted, branched or unbranched, cyclic or acyclic, and wherein any of the aryl or heteroaryl substituents described above and herein may be substituted or unsubstituted.

The following examples are intended to illustrate certain embodiments of the present invention, but do not exemplify the full scope of the invention.

### Example 1

The following examples describes the direct formation of a cobalt-based water oxidation catalyst from thin-film cobalt anodes.

Introduction: Efficient electrolysis of water to hydrogen and oxygen driven by sunlight is a longstanding goal envisioned for clean energy storage. The four proton, four electron proton-coupled electron transfer (PCET) reaction required to achieve water splitting generates high energy barriers to this molecular transformation. Molecular catalysts and other catalytic materials are sought to ease the energy input requirement for water oxidation. Although commercial electrolysis systems exist, these systems typically operate under harsh chemical conditions and often are constructed using costly catalytic materials. Thus, the need for an inexpensive catalytic material that operates under chemically neutral conditions (pH ˜7) persists for electrolyzers designed to penetrate the general, non-commercial market.

Recently, a catalyst formed from Co²⁺ ions in a potassium phosphate (KPi) buffered solution (Co-Pi) that is capable of catalyzing oxygen evolution from water at very low over-potentials has been developed by Nocera and coworkers (e.g., see Kanan et al., Science 2008, 321, 1072-5). Initial development, characterization and mechanistic understanding of the Co-Pi water oxidation catalyst is already extensively described (e.g., see Surendranath et al., J. Am. Chem. Soc. 2009, 131, 2615; Lutterman et al., J. Am. Chem. Soc. 2009, 131, 3838; Kanan et al., Chem. Soc. Rev. 2009, 38, 109). Discovery of this new oxygen evolving catalyst that is not only inexpensive, but also efficient, scalable and operable under the benign conditions of neutral pH water at atmospheric temperature and pressure creates much interest in the scientific and industrial communities.

Integration of the Co-Pi catalyst into photoanodes or a photoelectrochemical cell can enables use of the catalyst in a functional, marketable device. Advancing the versatility of Co-Pi towards this end involves development of alternative synthesis methods for the catalytic material. In initial reports of the Co-Pi catalyst, formation of the catalytic material was achieved via electrodeposition of Co²⁺ ions from aqueous solutions of 5 mM cobalt nitrate and 0.1 M potassium phosphate (KPi) buffer at pH 7. Upon formation of the Co-Pi catalyst film, the electrode was removed from the initial Co²⁺/KPi solution and placed in a solution of 0.1 M or 1 M KPi for continued operation. Two technological difficulties arise when considering this deposition technique on the backdrop of device manufacture. (1) While the initial Co-Pi formation takes place in a 5 mM cobalt nitrate and 0.1 M KPi solution, long term stability of the Co-Pi catalytic reaction was achieved only in solutions of 0.1 M or 1 M KPi. A method that utilizes the KPi solutions, but eliminates the need for the cobalt nitrate simplifies integration of the Co-Pi catalyst into device architectures. (2) The underlying device (i.e. photoanode or photoelectrochemical cell) that is covered by the catalyst film may include materials that are susceptible to corrosion or degradation under the aqueous environment in which the Co-Pi catalyst forms and operates. Therefore, incorporation of a cobalt metal protective layer for the underlying photoactive materials is technologically advantageous.

This example describes a new approach for Co-Pi formation. Formation of the Co-Pi catalyst presented herein was achieved from solutions of KPi (pH 7) through use of the cobalt metal thin-film electrode as the Co²⁺ cation source. The elemental composition of the Co-Pi catalyst material formed on thin-film cobalt electrodes was compared to that Co-Pi catalyst films formed on FTO-coated glass and found to be approximately the same. The catalytic activity of Co-Pi films on each electrode were also found to be comparable.

Cobalt Thin-Film Electrode Preparation: A thin film of cobalt metal (800 nm) was RF sputter deposited onto a room temperature glass substrate. The electrically insulated glass substrate ensured that the anodic current delivered during the formation of Co-Pi passes through the cobalt thin film. This cobalt metal electrode served as the working electrode in an electrochemical cell with an Ag/AgCl reference electrode and a platinum mesh counter electrode. A piece of copper foil tape with conductive epoxy was applied to the top of the cobalt metal electrode. A copper alligator clip was affixed at the position of the copper tape to connect the electrode to the electrochemical setup. Co-Pi formation was performed under an anodic potential of 1.1 V versus Ag/AgCl in 0.1 M KPi. Application of an anodic current to the cobalt metal generated Co²⁺ ions that undergo a PCET reaction with the KPi solution to form thin films of the Co-Pi catalyst.

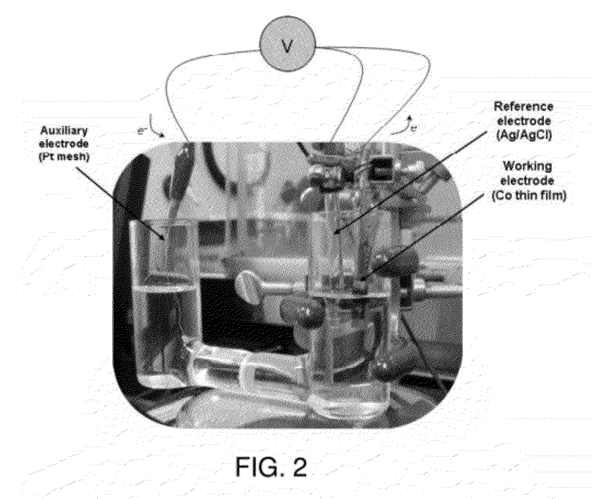

FIG. 2 shows an image of the electrochemical cell utilized for formation and electrochemical characterization of the Co-Pi catalyst. The two compartment cell was separated by a white semi-permeable frit located in the middle of the H-shaped cell. The anodic reaction occurred on the right side of the cell. The working electrode was either the Co thin-film electrode or an FTO-coated glass electrode. The Ag/AgCl reference electrode was positioned in close proximity to the working electrode. The cathodic reaction occurred on the right side of the cell shown. The auxiliary (or counter) electrode was a platinum mesh connected to a platinum wire. The Pt mesh allowed high passage of current ensuring that the cathodic reaction does not impose current limitations on the functioning of the electrochemical cell. A potentiostat (represented as “V”) was utilized to drive the electrochemical cell and record current and charge passed during operation.

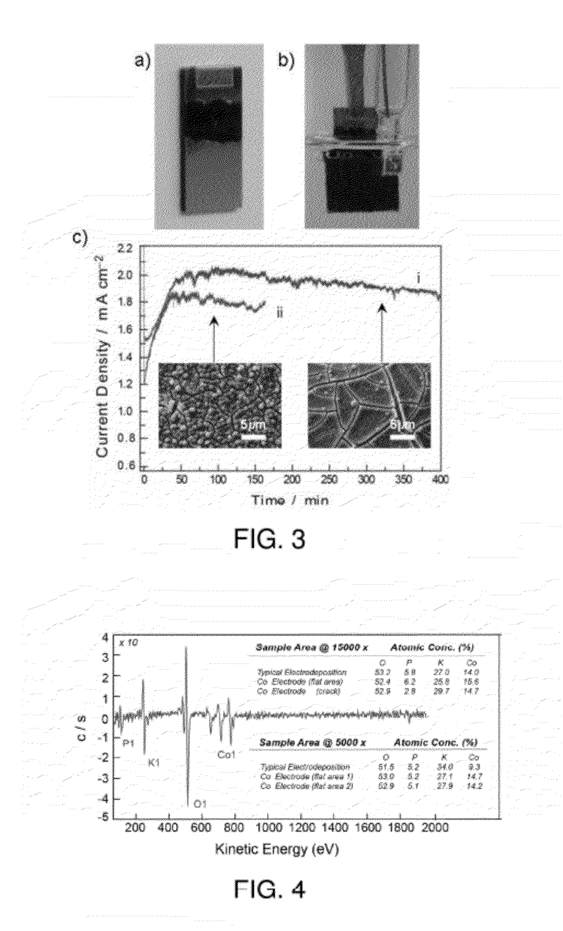

Prior to Co-Pi deposition, the middle one-third of the electrode was masked with an electrochemical stop-off masking lacquer (MICCROStop, Tolber Chemical Division) as shown in FIG. 3. The masked area was positioned at the air-water interface in the electrochemical cell. In the absence of the masking lacquer, during the application of electrical bias, a portion of the cobalt metal thin film dissolved away from the glass substrate exactly at the position of the air-water meniscus. As oxidation of the cobalt metal occurred, the fluctuations present at the interface washed or shuttled the Co²⁺ ions away from the electrode faster than they reacted with the KPi buffer to form a stable catalytic layer. This process caused a short in the electrochemical cell, halted further to deposition of the Co-Pi, and ceased catalytic activity. Use of the electrochemical stop-off masking lacquer enabled long term use of the electrode for Co-Pi deposition and water oxidation.

FIG. 3 shows (A) thin-film cobalt electrode with copper tape and Microstop lacquer, (B) thin-film cobalt electrode immersed in 0.1 M KPi under operation in catalytic regime, (C) current density traces for bulk electrolysis at 1.1 V (versus Ag/AgCl) in 0.1M KPi electrolyte, pH 7, for (ii) Co-Pi formation on FTO-coated glass anodes with 0.5 mM Co²⁺, and (i) Co-Pi formation on thin-film cobalt anodes. Both electrodes demonstrate comparable competence in current passage throughout the bulk electrolysis Co-Pi film deposition. SEM images at 5000 times magnification of the Co-Pi film formed on each electrode are shown.

Co-Pi Catalyst Deposition and Characterization. Comparison between Co-Pi catalyst films formed on thin-film cobalt electrodes and on the previously reported FTO-coated glass substrates was conducted to evaluate the relative activity of the catalyst formed by the cobalt film electrode method. Formation of the Co-Pi catalyst was performed in a two compartment cell by controlled potential electrolysis at 1.1 V versus Ag/AgCl as shown in FIG. 2. The working electrode was either the cobalt thin film deposited on glass or FTO-coated glass substrates. The electrolyte solution, 0.1 M KPi, was used in both compartments. For Co-Pi formation on the cobalt thin-film electrode, only the electrolyte was present in both compartments. For Co-Pi depositions on the FTO-coated glass substrates, the compartment containing the working and reference electrodes was infused with 0.5 mM Co²⁺. The thin-film cobalt electrode during production of molecular oxygen is shown in FIG. 3B.

Current density traces for Co-Pi deposition are shown in FIG. 3C for each method: (1) the solution-based method onto an FTO-coated glass electrode and (2) the cobalt metal thin-film method. The current traces show comparable current densities (between ˜1.8 and 2 mA/cm²) during the first hour of catalyst electrodeposition. Upon formation of the catalytic layer in the all-solution method, the electrode was placed into a fresh solution of 1 M KPi to continue catalytic activity. The cobalt thin-film anode, however, remained in the original KPi buffer solution. During controlled potential electrolysis lasting 15 hours, the cobalt thin-film anode remained intact and catalytically active. The cobalt films were fully transformed during this process as evidenced by a distinct color change observed through the glass substrate on the back side of the cobalt electrode. Analysis of the final KPi electrolyte solution with inductively coupled plasma atomic emission spectroscopy (ICP-AES) revealed a Co²⁺ ion concentration of 0.41 mg/L. This indicated that a 27 nm thick film of cobalt metal transferred to the solution from the 1 cm² substrate area, 3.4% of the initial 800 nm layer thickness.

Surface analysis of the dried electrodes was performed with SEM and Auger electron spectroscopy (AES) to characterize the morphology and composition of the deposited catalytic layer. SEM images revealed cracks in the catalytic layer that have previously been reported upon drying of the sample (e.g., see Kanan, M. W.; Nocera, D. G. Science 2008, 321, 1072-5). One noticeable difference between the two electrode surfaces shown in FIG. 3C is in the smoothness of catalytic film surface. The all-solution method produced rough surfaces with many nodules. The catalytic film layer formed on the Co metal thin-films is smoother, showing fewer and less prominent nodules.

AES analysis of the Co-Pi catalyst surfaces yielded the atomic concentrations of elements present within the first few nanometers of the surface. A representative AES spectrum for Co-Pi films is shown in FIG. 4. The inset table lists atomic concentrations for each element calculated from AES taken at 15000 and 5000 magnifications indicating substantially similar atomic concentrations of 0, P, K and Co at the surface of both types of the electrodes. This evidence confirmed that the essentially similar Co-Pi catalysts were formed.

FIG. 4 shows auger electron spectroscopy spectrum obtained for Co-Pi films formed on the cobalt thin-film electrode. Prominent Auger peaks for Co, 0, K, and P are labeled on the spectrum. Auger spectra obtained for Co-Pi film deposition on each electrode are substantially similar, so the FTO-electrode spectrum has been omitted for clarity. Atomic concentrations of each element present on the Co-Pi film surface are listed in the inset table.

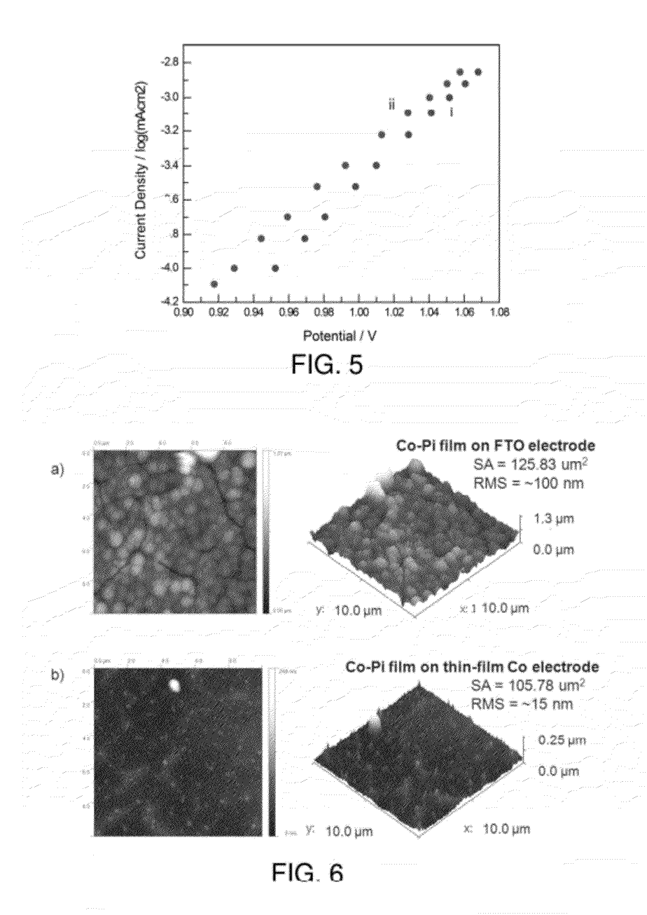

Water Oxidation Activity Comparison: The water oxidation activity of Co-Pi formed on the cobalt metal electrode is compared to that of the Co-Pi films formed by electrodepositon from Co²⁺ and KPi. Current density versus the applied potential in the electrochemical cell is plotted in a Tafel Plot in FIG. 5 where the current density measurement is a proxy for the catalytic activity. Specifically, FIG. 5 shows Tafel plots of the catalyst film operation under various applied potentials (versus to Ag/AgCl) for (ii) Co-Pi films on FTO (i) Co-Pi films on Co metal electrodes. The linear regime of the Tafel plot shows similar slopes for Co-Pi films on both FTO-coated glass and thin-film cobalt electrodes, indicating that the mechanism of water oxidation is similar for both electrodes. The slopes of the two Tafel plots are 110 mV/log unit and 100 mV/log unit, respectively, which are larger than 59 mV/log unit expected for a one-electron pre-equilibrium step to the reaction, as is implicated in the mechanism for Co-Pi catalysis. The larger slopes could be due to the significant thickness of the porous and amorphous Co-Pi films examined in this work, as the thick films can inhibit mass transport through the pores and add resistance to the electron transport throughout the film, both leading to larger Tafel slopes.

The slopes diverge at lower electrochemical potentials such that the Co-Pi films on the cobalt metal electrode demonstrates 35% less current density compared to the Co-Pi films on FTO at 0.95 V of applied potential.

Previous studies of Co-Pi films on FTO-coated glass electrodes have demonstrated ˜100% efficient use of passed current towards production of molecular oxygen. For the cobalt thin-film electrodes, the primary current loss mechanism is in the oxidative transformation of cobalt metal (Co⁰) to Co²⁺ cations, essential to the formation of the Co-Pi films. In Co-Pi film formation onto thin-film cobalt electrodes, electrolysis was performed over 15 hours resulting in the passage of 70 coulombs of charge. The amount of Co²⁺ measured in the remaining solution was 0.41 mg/mL (vide supra) or 0.417 μmol Co²⁺. If the entirety of the charge passed during the electrolysis had contributed to Co⁰ oxidation to Co²⁺, formation of 361 μmol Co²⁺ would have resulted. The actual amount of Co²⁺ released into solutions accounts for only 0.12% of the amount of charge passed. Therefore, nearly all of the charge contributed to Co-Pi formation, repair, and/or water oxidation on the cobalt metal electrodes just as is the case for Co-Pi films formed on FTO-coated glass. Co-Pi catalyst films formed on either FTO-coated glass or thin-film cobalt electrodes demonstrate very efficient use of current to perform water oxidation. The current output over a range of potentials exhibits similar slopes, indicating that both electrodes are competent for shuttling of charge and that the operative rate-determining step of the mechanism on each electrode remains constant.

FIG. 6 shows AFM images used to quantify the height profiles of the two Co-Pi films. FIG. 6A shows the Co-Pi film formed on FTO electrodes from the all-solution deposition method. FIG. 6B shows the Co-Pi film formed on the thin-film cobalt to electrodes with only 0.1 M KPi buffer. The Co-Pi films formed on the thin-film cobalt electrodes are significantly smoother with 16% of the surface area (SA) than the Co-Pi films formed on FTO electrodes when measured over the same 1 μm² substrate area. Note the different y-axis scales of the two AFM images. In a 100 μm² substrate area, the Co-Pi films on FTO possess a film surface area of 126 μm² (RMS=100 nm), whereas the thin-film cobalt electrodes have a film surface area of 106 μm² (RMS=15 nm).

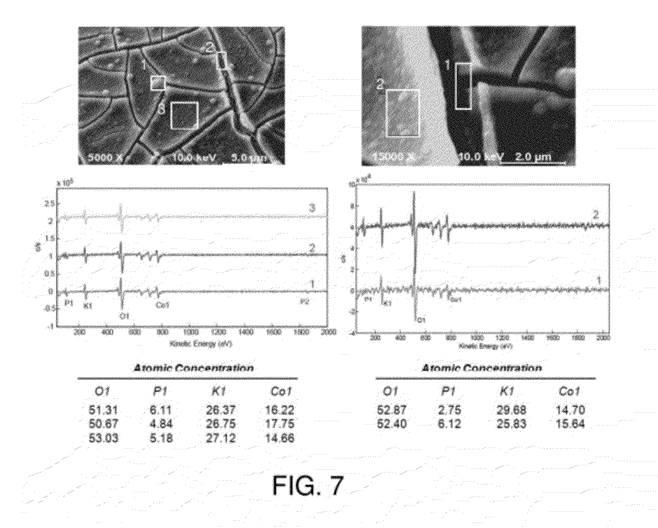

FIG. 7 shows images and Auger atomic concentration analysis for Co-Pi formed on cobalt thin-film electrodes

Conclusion: Thin-film cobalt metal electrodes deposited on non-conductive glass substrates were demonstrated to be effective sources of Co²⁺ cations necessary for the formation of Co-Pi catalyst films. Efficient formation of catalytic Co-Pi films in solutions of only KPi (pH 7) has been demonstrated. The chemical composition at the electrode as analyzed by AES reveals the comparable chemical makeup for the Co-Pi films present at the surface of the electrodes. SEM images revealed that the catalyst morphology was smoother on the thin-film cobalt metal electrodes, lacking the abundant nodules found for Co-Pi films on FTO-coated glass. Activity plots confirmed that the catalytic competence of the Co-Pi films on both FTO-coated glass or thin-film cobalt metal electrodes was approximately equal. These results indicate that cobalt metal can serve as an effective surface for Co-Pi catalyst formations and that the cobalt metal electrodes eliminate the need for solutions of Co²⁺. This demonstration suggest the possibility of using cobalt metal in future devices incorporating Co-Pi, potentially as a protective layer for soft semiconductors photo-anodes that otherwise experience photo-induced decomposition under the aqueous oxidative conditions.

Experimental Section Glass sheets were cut into 1×2 cm² substrates and the FTO coated glass substrates were purchased from (Hartford Glass) already cut to 1×2.5 cm² pieces. Cleaning of glass and FTO coated glass substrates consists of immersion is a dilute aqueous detergent (Micro90) and 5 minutes of sonication. The samples were then transfer into DI water and sonicated for 5 minutes, followed by 2 minutes of sonication in acetone and 2 minutes in boiling isopropanol. Each substrate was blown dry with nitrogen gas. Immediately prior to being coated with sputter deposited cobalt, the substrates were cleaned with oxygen plasma for 4 minutes. Sputter deposition was performed using an AJA international Orion 5 system. Electrochemistry was performed to with a CHI Instruments 760D Potentiostat/Galvanostat. Auger electron spectroscopy and SEM imaging was performed with a Physical Electronics Model 700 Scanning Auger Nanoprobe (LS). ICP-AES measurements were performed with a HoribaJobinYvon Activa ICP/OES spectrometer. Chemicals were purchased from Sigma Aldrich (KOH) or Aesar (KPi).

### Example 2

The following examples describes the direct formation of a cobalt-based water oxidation catalyst from thin-film cobalt anodes, where the cobalt thin-film is formed on a silicon substrate.

A thin film of cobalt metal (about 4 nm) was RF sputter deposited onto a room temperature Si substrate. A piece of copper foil tape with conductive epoxy was applied to the top of the cobalt metal electrode. A copper alligator clip was affixed at the position of the copper tape to connect the electrode to the electrochemical setup. Co-Pi formation was performed under an anodic potential of 1.1 V versus Ag/AgCl in 0.1 M KPi. Application of an anodic current to the cobalt metal generated Co²⁺ ions that undergo a PCET reaction with the KPi solution to form thin films of the Co-Pi catalyst.

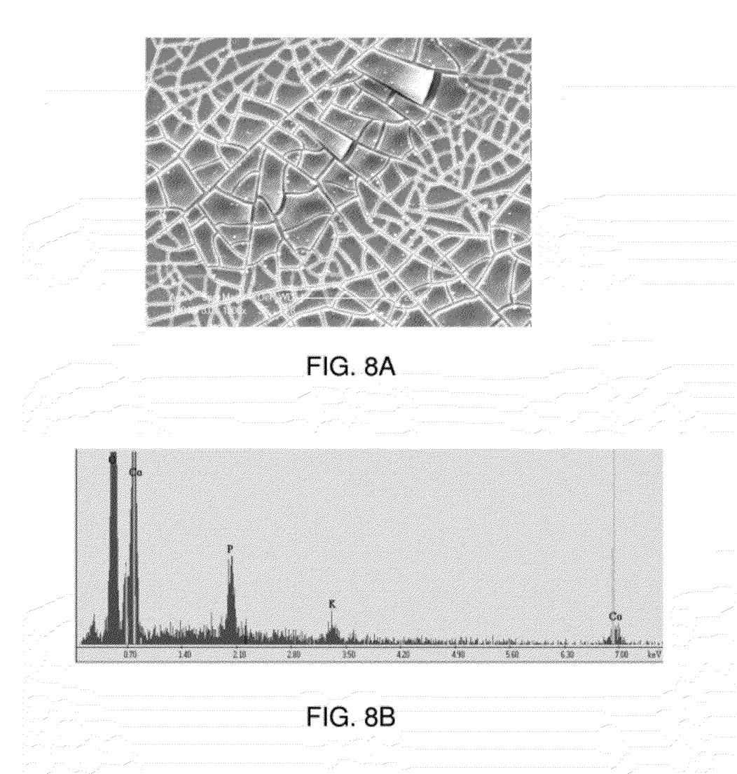

SEM analysis (see FIG. 8A) indicates that Co-Pi is formed form the Co metal on the Si electrode. EDAX analysis (see FIG. 8B) shows the presence of K and P peaks indicating that Potassium and Phosphorus are incorporated into the Co metal electrode to form Co-Pi.

### Example 3

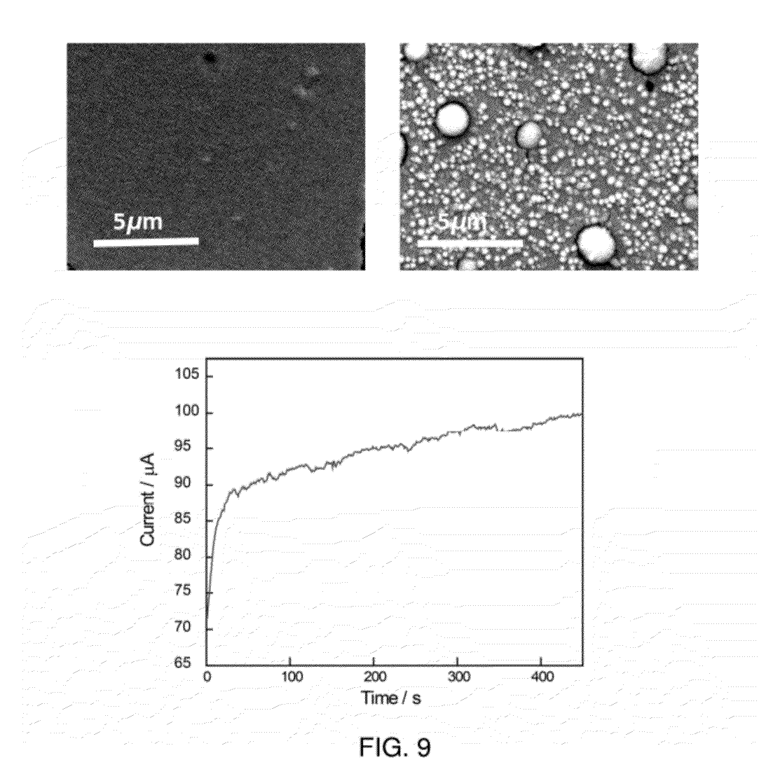

Nickel metal may also be employed (e.g., as compared to cobalt metal). In this example, an 800 nm layer of nickel metal and a solution comprising borate (e.g., 0.1 M borate, pH 9.2) was used. The deposition was carried out at 0.8 V versus Ag/AgCl. The electrode was annealed at 100° C. in vacuum. Representative SEM images and a plot of the current density versus time is shown in FIG. 9.

### Example 4

In this example, a silicon photoanode was used as a substrate for processing of cobalt metal films to form a cobalt-based water oxidation catalyst (Co-Pi). Silicon photoanodes with ITO and solution-deposited Co-Pi show catalytic onset at 1.05 V and those with only ITO contacts show no catalytic activity below 1.6 V. Co-Pi loaded silicon electrodes formed from Co thin films show improved catalytic onset at 0.85 V under illumination.

This example shows that the chemical electrocatalysis for water splitting can be powered by integrated photovoltaic devices, which demonstrates the light-powered water oxidation as a route for generation of solar fuels.

A manufacturable and scalable water-splitting catalyst (Co-Pi) formed under chemically benign conditions is technologically attractive for integration with photovoltaic devices or photoanodes in photoelectrochemical cells. Co-Pi films can be formed either via electrodeposition from Co²⁺ ions in aqueous solutions containing potassium phosphate (KPi) at pH 7 or by processing thin-films (800 nm thick) cobalt metal anodes on substrates in KPi at pH 7. Electrodes with the Co-Pi catalyst film can operate in Co²⁺ free solutions containing phosphate or borate buffers. The Co-Pi catalyst oxidizes water into oxygen at low applied overpotentials of 200 mV.

The light-assisted operation of the Co-Pi catalyst interfaced directly to high band-gap semiconducting metal oxide electrodes encourages its continued development for use in photoelectrochemical cells. In these metal oxide systems, the photoanode materials are in direct contact with aqueous solution during catalyst formation. In some cases, the stability of these underlying materials may undermine efficacy. The utility of the Co-Pi catalyst can be advanced by integrating it with a stable and well-researched photoanode material, such as silicon. The silicon photoanode absorbs light in the visible range enabling higher efficiency harvesting of the solar spectrum. In this example, doped silicon wafers are used as substrates for processing of the cobalt metal thin films into the Co-Pi catalyst.

### Experimental

Photoactive P—N junction silicon substrates were prepared from P-type silicon wafers, with N-type doping. The substrates were prepared by growing a 10-nm thick layer of SiO₂ (at of 10¹⁵ cm⁻³). The highly doped N-type contact layer was established by implantation of phosphorous atoms at energy of 20 keV, which led to the maximum concentration of 7×10¹⁹ atoms/cm³ at the Si/SiO₂ interface and a junction depth of around 200 nm. Then, rapid thermal annealing (900° C. for 10 s) in a forming gas was applied to reduce the implantation damage and activate the dopants, and was followed by chemically stripping the oxide layer.

Silicon wafers were cut into 1×2 cm² substrates. Immediately before introducing the substrates to the sputtering chamber (AJA International Orion 5 system), the substrates were immersed in 10% HF for silicon oxide removal. Low-pressure sputter deposition (10 mTorr) of a thin film of cobalt metal (800 nm thick) onto the P-type side and of indium tin oxide (ITO, 200 nm) onto the N-type side was performed at deposition rates of 1 Å/s (forming ITO/Si/Co structure). These layers served both as chemically protective layers and as electrical contacts to the wafer. Using the same silicon substrate, control photoanodes were also fabricated. The control photoanode comprised ITO contacts sputtered on both sides of the wafer (forming ITO/Si/ITO structure).

To form the water oxidation catalyst, the ITO/Si/Co electrode was immersed in a phosphate buffer solution and an anodic bias was applied to it for transforming of the cobalt to Co-Pi, as described previously, forming the final ITO/Si/Co/Co-Pi photoanode structure. A control photoanode comprised the ITO/Si/ITO structure with Co-Pi electrochemically deposited from solution on the P-type side (forming ITO/Si/ITO/Co-Pi structure), with deposition conditions described previously. Electrochemical deposition was performed in a two compartment H-cell using a CHI Instruments 760D Potentiostat/Galvanostat.

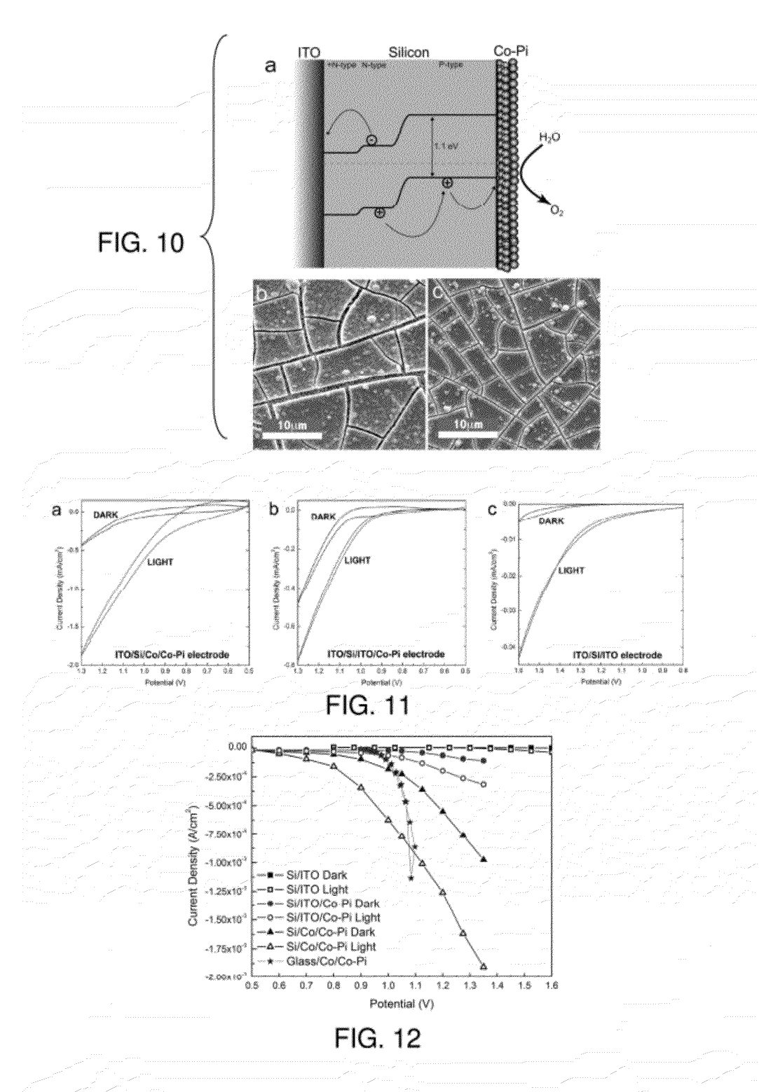

FIG. 10A shows a schematic of the device architecture for the ITO/Si/Co/Co-Pi photoanode. FIG. 10B shows an SEM image of the Co-Pi film formed on top of the ITO/Si/Co electrode after overnight processing under ambient conditions and a bias of 1.3V. FIG. 10C shows the Co-Pi film formed by electrodeposition on ITO/Si/ITO substrate at 1.1V (all potentials are reported versus Ag/AgCl reference electrode). The cracks seen in the SEM images are typical on Co-Pi films after drying. SEM images were acquired by a FEI/Philips XL30 FEG ESEM. Chemicals were purchased from Sigma Aldrich and Aesar. Specifically, FIG. 1 shows (a) Schematic of the silicon P—N junction photovoltaic device used as a photoanode coated with the thin film of Co-Pi catalyst on the P-side and the ITO electrode on the N-side. SEM images of (b) ITO/SI/Co/Co-Pi electrode and of (c) ITO/SI/ITO/Co-Pi electrode show similar morphologies. The cracks that appear in the images form due to the drying of the Co-Pi film prior to the SEM imaging.

Electrochemical characterization of the electrodes was performed in a quartz cell setup using a Pt mesh counter electrode, an Ag/AgCl reference electrode and 0.1 M phosphate buffer (pH 7). The working electrode was either the ITO/Si/ITO, ITO/Si/ITO/Co-Pi, or ITO/Si/Co/Co-Pi electrodes. In each case the electrode was masked using MICCROStop Laquer (Tolber Chemical Division) to define an active working area of 1 cm². The Ag/AgCl reference electrode was positioned in proximity to the working electrode.

Photolysis experiments were performed using a 1000 W Xe arc-lamp to characterize the behavior of the electrodes under illumination. The electrochemical cell was immersed in a water bath held at 10° C. that prevents heating of the sample, and also served as an IR filter for lamp irradiation. After passing through the filters and lenses of the photolysis setup, the lamp illumination intensity was equivalent to 2 suns. The incident photon flux above the bandgap of silicon (which corresponds to 37% of the solar spectrum) was 3.6×10²⁰ photons/sec·cm². The reflected number of photons from the illuminated ITO-covered N-type side was measured to be 6.3×10¹⁸ photons/sec·cm² (about 2% of the incident light). Thus, the samples absorbed about 3.54×10²⁰ photons/sec·cm², a value that was used for quantum yield calculations.

### Results and Discussion

FIG. 11 shows representative cyclic voltamograms (CV) of each photoanode structure under illumination and under dark conditions. FIG. 11A shows CVs taken in light and dark conditions for ITO/Si/Co/Co-Pi. FIGS. 11B and 11C show CV scans for the ITO/Si/ITO/Co-Pi and ITO/Si/ITO, respectively. Specifically, FIG. 11 shows cyclic voltamograms (CV) of (a) ITO/Si/Co/Co-Pi electrode, (b) ITO/Si/ITO/Co-Pi electrode and (c) ITO/Si/ITO electrode demonstrating the effect of light on current densities as conditions changed from dark to illuminated. Under illumination the ITO/Si/Co/Co-Pi exhibited the highest current densities, followed by ITO/Si/ITO/Co-Pi and ITO/Si/ITO. Note that both Y and X axes scales vary. Note that the axes have been scaled for each set of data. In fact, the current density passing through the ITO/Si/Co/Co-Pi photoanode under illumination was roughly two order of magnitude greater than through the ITO/Si/ITO and a factor of two greater than through the ITO/Si/ITO/Co-Pi. The onset of the catalytic wave varied for each electrode under both illumination conditions. The onset of water oxidation for the ITO/Si/ITO electrode occurred at 1.35 V under illumination, and was higher than 1.6 V in the dark. The onset of the catalytic action for water oxidation occurred at lower applied potentials for the Co-Pi loaded photoanodes. For ITO/Si/ITO/Co-Pi, the onset occurred at 1.1 V in dark and 0.95 V under illumination. Better activity was achieved for the ITO/Si/Co/Co-Pi electrode for which the onset occurs at 1.1 V in dark and as low as 0.85 V under illumination.

Differences in performance are particularly clear in FIG. 12, which shows a comparison of steady-state current versus applied potential curves under dark and light conditions for the three photoanodes and of a glass/Co/Co-Pi electrode from a previous study. Specifically, FIG. 12 shows current density vs. applied potential (I/V) curves for each electrode under dark and light conditions. The graph plots the steady-state current at each potential. The ITO/Si/ITO electrode showed minimal activity compared to the Co-Pi loaded electrodes. In dark conditions both Co-Pi loaded electrodes exhibited similar current densities; however, under illumination the ITO/Si/Co/Co-Pi electrode had significantly higher current densities than ITO/Si/ITO/Co-Pi. For comparison, an I/V curve from a previous work, corresponding to a glass/Co/Co-Pi electrode has been added (stars) to the new results to emphasize the improved, lower catalytic onset potential of the ITO/Si/Co/Co-Pi electrode under illumination.

The current density (mA/cm²) plotted at each applied potential was recorded at steady-state conditions after the current stabilized for each applied voltage. The ITO/Si/ITO electrode passed very little current (10 μA/cm²) compared to the Co-Pi loaded electrodes and showed negligible change between light and dark conditions. The ITO/Si/ITO/Co-Pi electrode exhibited higher dark current densities and demonstrated further increases under illumination. In this case, the current offset between dark and light conditions reached 200 μA/cm² at an applied potential of 1.35 V. The ITO/Si/Co/Co-Pi electrode reached current densities higher than the ITO/Si/ITO/Co-Pi electrode in dark conditions. In light conditions, the current density increased dramatically. The current offset between dark and light conditions over the catalytic regime of the electrode under illumination (between 0.85 V to 1.35 V) increased from 100 μA/cm² (at 0.85 V) to 1 mA/cm² (at 1.35 V) and even higher. The catalytic onset of the ITO/Si/Co/Co-Pi electrode under illumination occurred earlier than under all other conditions, including the glass/Co/Co-Pi electrode. Knowing the incident photon flux, the conversion yield of photons to charge per electrode was determined at a given applied potential. The applied potential of 1.35 V was used and the light induced currents were calculated. The quantum yield of the ITO/Si/ITO cells was measured to be 1.5×10⁻⁷ electrons/photons. For the ITO/Si/ITO/Co-Pi photoanode, the yield was higher at 3.7×10⁻⁶ electrons/photons. The ITO/Si/Co/Co-Pi photoanode achieved an order of magnitude higher quantum to yield than the ITO/Si/ITO/Co-Pi photoanode, and reached a yield of 1.7×10⁻⁵ electrons/photons.

Visual inspection of the electrodes at various potentials and illumination conditions revealed gas evolution at potentials as low as 0.85 V for ITO/Si/Co/Co-Pi electrodes under light illumination, whereas all other electrodes required higher potentials (e.g., above 1.1 V) to produce the same effect. The ITO/Si/Co/Co-Pi photoanode fabrication and processing provided a 250 mV advantage under illumination towards production of a given current density in the catalytic regime compared to the ITO/Si/ITO/Co-Pi.

Fabrication and characterization of this suite of silicon-based photoanodes demonstrates that integrating the Co-Pi catalyst with a photoanode may increase photocurrents. Silicon does not show water oxidation activity at potentials up to 1.35 V, even when conductive ITO contacts are used in place of the insulating native oxide. Integration of Co-Pi onto the silicon photoanode changed the behavior of the substrate, so that in dark, catalytic onset occurs at 1.1 V. Although in dark conditions both the ITO/Si/ITO/Co-Pi and the Si/Co/Co-Pi exhibit similar current densities, under illumination the ITO/Si/Co/Co-Pi achieves higher current densities. This performance enhancement might arise from a better, more ohmic contact formed between the Co-Pi layer and the underlying silicon substrate in the Si/Co/Co-Pi electrode than between the Co-Pi layer, the ITO and the silicon contacts of the ITO/Si/ITO/Co-Pi photoanode.

When considering the energy band structure of silicon with respect to the water oxidation potential, it is noted that the valence band of silicon may not be at an oxidative potential versus the water/oxygen couple. Therefore it is not trivial that a silicon photoanode will assist in water oxidation under illumination. This study shows that the proper integration of a silicon photoanode and a catalytic material for water oxidation can improve the light-assisted catalytic activity and may lower applied potentials necessary to achieve water oxidation.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used.

Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such to as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed:

1. A method for making an electrode comprising a catalytic material, comprising:
immersing a current collector in a solution comprising anionic species, wherein the current collector comprises a layer of a metallic species in an oxidation state of zero, wherein the layer of the metallic species has an average thickness of less than about 2 mm; and
causing a catalytic material to form on the current collector by application of a voltage to the current collector, wherein the catalytic material comprises the metallic species in an oxidation state greater than zero and the anionic species.

2. A method for making an electrode comprising a catalytic material, comprising:
immersing a current collector in a solution comprising anionic species, wherein the current collector comprises a metallic species in an oxidation state of zero; and
causing a catalytic material to form on the current collector by application of a voltage to the current collector, wherein the catalytic material comprises the metallic species in an oxidation state greater than zero and the anionic species, wherein following formation of the catalytic material, the current collector comprises less than about 10% of the metallic species in an oxidation state of zero.

3. An electrode comprising a catalytic material produced by:
immersing a current collector in a solution comprising anionic species, wherein the current collector comprises a layer of a metallic species in an oxidation state of zero, wherein the layer of the metallic species has an average thickness of less than about 2 mm; and
causing a catalytic material to form on the current collector by application of a voltage to the current collector, wherein the catalytic material comprises the metallic species in an oxidation state greater than zero and the anionic species.

4. An electrode comprising a catalytic material produced by:
immersing a current collector in a solution comprising anionic species, wherein the current collector comprises a metallic species in an oxidation state of zero; and
causing a catalytic material to form on the current collector by application of a voltage to the current collector, wherein the catalytic material comprises the metallic species in an oxidation state greater than zero and the anionic species, and wherein following formation of the catalytic material, the current collector comprises less than about 10% of the metallic species in an oxidation state of zero.

5. The method of claim 1, wherein the metallic species is cobalt.

6. The method of claim 1, wherein the anionic species comprises phosphorus.

7. The method of claim 6, wherein the anionic species comprising phosphorus is a form of phosphate.

8. The method of claim 2, wherein the current collector comprising metallic species further comprises a core material.

9. The method of claim 8, wherein the core material is a conductive material.

10. The method of claim 8, wherein the core material is substantially coated by the metallic species.

11. The method of claim 8, wherein the current collector is formed by sputtering the metallic species onto the core material.

12. The method of claim 8, wherein the metallic species is formed as a film on at least a portion of the conductive material.

13. The method of claim 12, wherein the thickness of the film is at least about or about 1 nm, at least about or about 10 nm, at least about or about 50 nm, at least about or about 100 nm, at least about or about 200 nm, at least about or about 300 nm, at least about or about 400 nm, at least about or about 500 nm, at least about or about 600 nm, at least about or about 700 nm, at least about or about 800 nm, at least about or about 900 nm, at least about or about 1 um (micrometer), at least about or about 10 um, at least about or about 100 um, or at least about or about 1 mm.

14. The method of claim 1, wherein a portion of the metallic species having an oxidation state of zero is oxidized to an oxidation state of (n−x) upon application of a voltage.

15. The method of claim 14, wherein a portion of the metallic species oxidized to an oxidation state of (n−x) are further oxidized to an oxidation state of (n).

16. The method of claim 15, wherein the catalytic material comprises at least a portion of the metallic species in an oxidation state of (n) and the anionic species.

17. The method of claim 14, wherein (n) is 2, 3, or 4.

18. The method of claim 14, wherein (x) is 0, 1, or 2.

19. The electrode of claim 3, wherein the current collector is associated with a masking lacquer.

20. The electrode of claim 19, wherein the masking lacquer is formed at an air-solution interface of the current collector.

21. The method of claim 1, wherein the solution comprises water.

22. The method of claim 1, wherein the pH of the solution is between about 5 and about 8, or between about 6 and about 8, or between about 6.5 and about 7.5, or about 7.

23. The method of claim 1, wherein the voltage is applied to the current collect for between about 1 minute and about 24 hours.

24. The method of claim 1, wherein the voltage is applied at a potential of at least about 1.0 V, or about 1.1 V, or about 1.2 V, or about 1.3 V, or about 1.4 V, or about 1.5 V.

25. The method of claim 15, wherein the Kₛₚ value of the catalytic material comprising the metal ionic species with an oxidation state of (n) and the anionic species is less than a material comprises metal ionic species with an oxidation state of (n−x) and anionic species by at least a factor of 10³.

26. The method of claim 1, wherein the layer of the metallic species has an average thickness of less than about 1.5 mm, or less than about 1 mm, or less than bout 900 microns, or less than bout 800 microns, or less than bout 700 microns, or less than bout 600 microns, or less than bout 500 microns, or less than bout 400 microns, or less than bout 300 microns, or less than bout 200 microns, or less than bout 100 microns.

27. The method of claim 1, wherein the layer of the metallic species has a maximum thickness of no more than about 100 microns, or no more than about 200 microns, or no more than about 300 microns, or no more than about 400 microns, or no more than about 500 microns, or no more than about 600 microns, or no more than about 700 microns, or no more than about 800 microns, or no more than about 900 microns, or no more than about 1 mm, or no more than about 1.5 mm.

28. The method of claim 1, wherein following formation of the catalytic material, the current collector comprises less than about 8%, or less than about 7%, or less than about 6%, or less than about 5%, or less than about 4%, or less than about 3%, or less than about 2%, or less than about 1%, or less than about 0.5%, or less than about 0.3%, or less than about 0.1%, of the metallic species in an oxidation state of zero.

29. The method of claim 1, further comprising producing oxygen gas at the electrode.

30. The method of claim 8, wherein the core material is a semiconductor material.

31. The method of claim 30, wherein the semiconductor material is an n-type semiconductor material.

32. The method of claim 30, wherein the semiconductor material is photoactive.

33. An electrolytic device comprising an electrode of claim 3.

34. A regenerative fuel cell comprising an electrode of claim 3.
